(19) United States
(12) Patent Application Publication
(10) Pub. No.: US 2012/0193575 A1
(43) Pub. Date: Aug. 2, 2012

(54) STABILIZED SURFACTANT - OXIDANT COMPOSITION AND RELATED METHODS

(75) Inventors: George E. Hoag, Bloomfield, CT (US); John B. Collins, Bloomfield, CT (US)

(73) Assignee: VeruTEK, Inc., Bloomfield, CT (US)

(21) Appl. No.: 13/502,022

(22) PCT Filed: Oct. 13, 2010
(86) PCT No.: PCT/US10/52520

§ 371 Date: Apr. 13, 2012

Related U.S. Application Data
(60) Provisional application No. 61/251,291, filed on Oct. 13, 2009.

(51) Int. Cl. C01B 15/037; C09K 3/00

(52) U.S. Cl. 252/186.29; 423/272

(57) ABSTRACT

The present invention relates to compositions stabilized surfactant-oxidant mixtures, and methods of making and using them. For example, in some embodiments the present invention relates to adding a plant-derived surfactant to stabilize an oxidant in a liquid.

### FIELD OF THE INVENTION

The present invention relates to methods for making and using and compositions of stabilized surfactant-oxidant mixtures. For example, the present invention relates to compositions and methods comprising adding a plant-derived surfactant to a mixture in order to stabilize an oxidant.

### BACKGROUND

Oxidant compounds, such as persulfates and peroxides, have a wide range of industrial uses. However, the instability of such oxidant compounds can constrain their application or require inconvenient measures. The premature decomposition of an oxidant compound and the formation of products such as radicals can itself be undesirable. Furthermore, the premature decomposition of an oxidant compound during storage or transport can result in an insufficient concentration of the oxidant compound being available for the intended application of the compound.

### SUMMARY

In one aspect, the invention provides compositions. The compositions can be, for example, storage-stable compositions comprising a nonionic plant-derived surfactant in a concentration of at least about 10 g/L, and an oxidant in a concentration of about 1% (w/v) to about 10% (w/v), wherein the oxidant is stable during the shelf life of the composition. The oxidant can be, for example, hydrogen peroxide. The hydrogen peroxide concentration can be, for example, about 1% (w/v) to about 4% (w/v). The shelf life can be, for example, at least about 1 month, or at least about 3 months, or at least about 6 months. The plant-derived surfactant concentration can be, for example, about 10 to about 100 g/L, or about 50 to about 100 g/L. The plant-derived surfactant include one or more of, for example, an ethoxylated soybean oil, an ethoxylated castor oil, an ethoxylated coconut fatty acid, and an amidified, ethoxylated coconut fatty acid. The compositions can, for example, further comprise a cosolvent. The cosolvent can include, for example, one or more of a carboxylate ester, a plant-based ester, a terpene, a citrus-derived terpene, limonene, d-limonene, isopropyl alcohol, t-butyl alcohol and combinations. The pH of the composition can be, for example, from about 4 to about 7. The compositions can further comprise a stannate in an amount less than about 150 mg/L as tin. The compositions can also comprise, for example, a phosphonic acid compound in an amount less than about 0.025 percent of the hydrogen peroxide concentration. The compositions can be, for example, essentially free of anionic surfactants. The plant-derived surfactant can be, for example, resistant to degradation by the oxidant, and/or the oxidant can be, for example, resistant to degradation by the plant-derived surfactant.

In some embodiments, the invention provides storage-stable compositions. The compositions can comprise, for example, a plant-derived surfactant and an oxidant, wherein the surfactant concentration is at least about 10 g/L, and the ratio of the mass per volume concentration of plant-derived surfactant to the mass per volume concentration of the oxidant is greater than about 1:5; and wherein the oxidant is stable during the shelf life of the composition. The oxidant can be, for example, hydrogen peroxide. The shelf life can be, for example, at least about 1 month, or at least about 3 months, or at least about 6 months. The compositions can, for example, have a ratio of the mass per volume concentration of plant-derived surfactant to the mass per volume concentration of the oxidant from about 20% to about 100%.

In some embodiments, the storage stable compositions can comprise, for example, a nonionic plant-derived surfactant in a concentration of greater than 2 g/L and a peroxide such as hydrogen peroxide in a concentration of at least about 1% (w/v), wherein the oxidant and the surfactant are stable for at least one month, or at least about three months, or at least about six months. They hydrogen peroxide concentration can be, for example, about 1% (w/v) to about 10% (w/v), or about 1% (w/v) to about 8% (w/v). The surfactant concentration can be, for example, at least about 3 g/L.

In another aspect, the invention provides methods for reducing the concentration of a contaminant in a medium. These methods can comprise, for example, obtaining one or more of the compositions disclosed herein, and combining the composition with the contaminant, thereby reducing the concentration of contaminant in or on the medium.

In still another aspect, the invention provides methods for making the storage-stable compositions disclosed herein. The methods can comprise, for example, combining the surfactant and oxidant in a container to make the composition and storing the composition in the container for at least about 1 month.

### BRIEF DESCRIPTION OF THE DRAWINGS

FIGS. 1a-1f present photographs of vials I-1 through I-12 at times of 0, 1.5, 2, 4, 24, and 72 hours following preparation of the solutions, respectively.

FIGS. 2a-2g present close-up photographs of vials I-1 through I-4 and I-12 at times of 0, 1.5, 2, 3, 4, 24, and 72 hours following preparation of the solutions, respectively.

FIGS. 3a-3f present graphs depicting the change in bromothymol blue concentration over time in samples I-1 to I-4 and I-12 over time, as measured using, e.g., spectrographic scans in FIGS. 3b-3f, corresponding to vials I-1 through I-4 and I-12, respectively.

FIG. 4a-4g present close-up photographs of vials I-7 through I-11 at times of 0, 1.5, 2, 3, 4, 24, and 72 hours following preparation of the compositions, respectively.

FIGS. 5a-5f present graphs depicting the change in bromothymol blue concentration over time in samples I-7 to I-11 over time, as measured using, e.g., spectrographic scans in FIGS. 5b-5f, corresponding to vials I-7 through I-11, respectively.

FIG. 6 is a graph depicting the stabilization effects of disclosed compositions on hydrogen peroxide in the presence of green synthesized nanoscale zero valent iron.

FIG. 7 is a graph depicting interfacial tension measurements in effluents from soil columns containing ASTM fine sand and coal tar DNAPL, and receiving an influent of either hydrogen peroxide, Fe-EDTA and surfactant (Column 4) or only hydrogen peroxide and Fe-EDTA (Column 5).

FIG. 8 is a graph depicting hydrogen peroxide levels in effluents from soil columns containing ASTM fine sand and coal tar DNAPL, and receiving an influent of either hydrogen peroxide, Fe-EDTA and surfactant (Column 4) or only hydrogen peroxide and Fe-EDTA (Column 5).

FIG. 9 is a bar graph depicting the soil petroleum hydrocarbons (TPH) concentrations in initial soil samples as well as those treated with S-ISCO™ and ISCO.

FIG. 10 is a bar graph depicting concentrations of polyaromatic hydrocarbons (PAH), ethyl benzene, toluene and xylenes (BTEX) and benzo[α]pyrene equivalents in initial soil samples as well as those treated with S-ISCO™ and ISCO.

FIG. 11 is a graph depicting the effects of VeruSOL-3 and VeruSOL-10 on stabilization of hydrogen peroxide, as measured by hydrogen peroxide concentration, over a 7 month period with 20 g/L of VeruSOL-3 or VeruSOL-10.

FIG. 12 is a graph depicting the long term storage stability of VeruSOL-3 and VeruSOL-10, as measured by interfacial tension, in 8% and 30% hydrogen peroxide compositions over 7 months.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention.

As used herein, an “oxidant” is a chemical or agent that removes electrons from a compound or element, increases the valence state of an element, or takes away hydrogen by the addition of oxygen. In this text, the term “oxidant” includes all oxidizing compounds or compounds that decompose or react to form an oxidizing compound. For example, the term “oxidant” includes solid, liquid, or gaseous compounds that can decompose to liberate oxygen or an oxidizing species. For example, the term “oxidant” includes compounds such as persulfates, percarbonates, peroxides, hydrogen peroxide, and permanganates. For example, the term “oxidant” also includes oxidizing gases, such as oxygen, ozone, and air. For example, the term “oxidant” also includes dissolved gases, such as oxygen or ozone dissolved in an aqueous or non-aqueous liquid.

As used herein, “medium” encompasses any location or item in which contaminants can be found. For example, “medium” includes, without limitation, a biologically contaminated material, soil, groundwater, water, wastewater, air, and combinations thereof. “Medium” also encompasses any container, surface or other object on which contaminants may be found. As such, “medium” also includes, for example, countertops, dishes, windows, bathroom fixtures including toilets, countertops, mirrors, sinks, bathtubs, grease traps, and any other surface, whether in a factory, restaurant or other commercial facility, a home, a car or in another object or structure, that may contain contaminants that can be removed using the compositions and methods disclosed herein.

“Contaminant” encompasses any substance present in a location that, by its presence, diminishes the usefulness of the location for productive activity or natural resources, or would diminish such usefulness if present in greater amounts or if left in the location for a length of time. The location may be subsurface, on land, in or under the sea or in the air. As used herein, “contaminated soil” encompasses any soil that contains at least one contaminant according to the present invention. “Contaminant” thus can encompass trace amounts or quantities of such a substance. Examples of productive activities include, without limitation, recreation; residential use; industrial use; habitation by animal, plant or other life form, including humans; and similar such activities. Examples of natural resources are aquifers, wetlands, sediments, soils, plant life, animal life, ambient air quality. As used herein, “contaminant” also includes any substance on a surface or in a container, the presence of which may be undesirable, e.g., those which are associated a state of non-cleanliness. As such, “contaminant” also includes, for example, dirt, dust, grease, grime, mold, mildew, smudges, spill residue, food residue, and other substances or residues of substances that can appear on industrial, commercial, household, automotive or other containers or surfaces.

Surfactant enhanced in situ chemical oxidation (S-ISCO™) remediation depends on choosing the correct surfactants or surfactant-cosolvent mixtures that create the most effective solubilized micelle or microemulsion with the NAPL present in the soil, such that a Winsor Type I phenomenon occurs and other Winsor type behaviors are generally avoided. Once an adequate Winsor Type I solubilized micelle or microemulsion has formed and thus increases the apparent solubility of the NAPL, the solubilized micelle or microemulsed NAPL is able to enter into “aqueous phase reactions” and in the case of S-ISCO™ remediation, it can be oxidized using a chemical oxidant such as a permanganate, an alkali metal permanganate, potassium permanganate, molecular oxygen, ozone, a persulfate, an alkali metal persulfate, sodium persulfate, an activated persulfate, a percarbonate, an activated percarbonate, a peroxide, an alkali earth peroxide, calcium peroxide, or hydrogen peroxide, or ultraviolet (uV) light or any combination of these oxidants with or without uV light. It is well known in the literature that several methods can be used to activate or catalyze peroxide and persulfate to form free radicals such as free or chelated transition metals and uV light. Persulfate can be additionally activated at both high and low pH, by heat or by peroxides, including calcium peroxides. Persulfate and ozone can be used in a dual oxidant mode with hydrogen peroxide.

In some embodiments, the invention relates to a method and process for increasing the solubility of contaminants, such as normally low solubility nonaqueous phase liquids (NAPLs), sorbed contaminants, or other chemicals in soils in surface and ground water, and simultaneously or subsequently oxidizing the chemicals using a chemical oxidant without the need of extraction wells for the purpose of recovering the injected cosolvents and/or surfactants with NAPL compounds. Examples of contaminants are dense nonaqueous phase liquids (DNAPLs), light nonaqueous phase liquids (LNAPLs), polycyclic aromatic hydrocarbons (PAHs), chlorinated solvents, pesticides, polychlorinated biphenyls and various organic chemicals, such as petroleum products. Contaminants can be associated with, for example, manufactured gas plant residuals, creosote wood treating liquids, petroleum residuals, pesticide, or polychlorinated biphenyl (PCB) residuals and other waste products or byproducts of industrial processes and commercial activities. Contaminants may be in the liquid phase, for example, NAPLs, sorbed to the soil matrix or in the solid phase, for example, certain pesticides.

In some embodiments, a treated composition includes soil, an oxidized contaminant, and an oxidant residue. The contaminant may be oxidized to minerals. For example, a hydrocarbon may be completely oxidized to carbon dioxide and water.

The screening of several surfactants, cosolvents, or surfactant-cosolvent mixtures for dissolution and/or desorption of a given NAPL or sorbed organic chemical (or mixture of chemicals) can lead to a customized and optimal surfactant, cosolvent, or surfactant-cosolvent mixture to dissolve either some or all of the NAPLs or sorbed chemicals. In order to dissolve some or all of the NAPLs or sorbed chemicals, a surfactant or mixture of surfactants alone, a cosolvent or mixture of cosolvents alone, or a mixture of surfactants and cosolvents can be used. For example, certain volatile constituents in the NAPLs may pose a health or ecological risk at a particular site, that is, be contaminants of concern (COCs), but the NAPLs may contain many other compounds that do not result in risks. This invention presents methods to screen different types of surfactants, cosolvents, and cosolvent-surfactant mixtures to obtain an optimal dissolution or desorption of the contaminants of concern, resulting in the oxidation predominantly only of those compounds that need to be treated to reduce risk or reach remediation goals for a given site.

The term “solubilize” as used herein can encompass incorporating a contaminant in the aqueous phase, forming a molecular scale mixture of contaminant and water, incorporating contaminant at a micellar interface, and/or incorporating contaminant in a hydrophobic core of a micelle. The term “solution” as used herein can refer to, for example, a contaminant in the aqueous phase, a molecular scale mixture of contaminant and water, a contaminant at a micellar interface, and a contaminant in a hydrophobic core of a micelle.

The oxidant and surfactant or surfactant-cosolvent mixture can be selected so that the oxidant does not substantially react with the surfactant or cosolvent. Alternatively, the oxidant and surfactant or surfactant-cosolvent mixture can be selected so that the surfactant can function to solubilize contaminant, for example, NAPL, even if the oxidant reacts with the surfactant or cosolvent. Alternatively, the oxidant and surfactant or surfactant-cosolvent mixture can be selected so that the oxidant reacts with the surfactant so as to promote the destruction of contaminant, for example, NAPL. For example, the oxidant may react with the surfactant to alter the chemistry of the surfactant, so that the altered surfactant selectively solubilizes certain contaminants. For example, an oxidant can be chosen that modulates the interfacial tension of the resultant soil NAPL/water interface and promotes selective solubilization of surface contaminants.

In some embodiments, an amount of surfactant or surfactant-cosolvent mixture is introduced into a subsurface, for example, rock, soil, or groundwater, including a contaminant, for example, a NAPL, to form a Winsor Type I system. In order to form a Winsor Type I system, the amount of surfactant or surfactant-cosolvent mixture added is controlled and restricted; that is, not so much of a surfactant or surfactant-cosolvent mixture is added to induce the formation of a Winsor Type II system, but enough to result in increased solubilization of the NAPL above the aqueous critical micelle concentration. Thus, the formation of a Winsor Type II system and the mobilization of contaminant, for example, NAPL, associated with a Winsor Type II system, is avoided or minimized. By avoiding or minimizing the mobilization of contaminant, the problem of contaminant migrating to areas not being treated can be avoided.

The mobilization of contaminant can also be avoided by controlling the rate of oxidation in the subsurface. For example, by ensuring that the overall rate of oxidation of contaminant is greater than the overall rate of solubilization of contaminant, mobilization can be avoided. The overall rate of oxidation can be controlled by controlling the concentration of oxidant in the subsurface. For example, if a greater mass of oxidant is introduced into a given volume of subsurface, then the concentration of oxidant in that volume will be greater and the rate of oxidation will be faster. On the other hand, if a lesser mass of oxidant is introduced into a given volume of subsurface, then the concentration of oxidant in that volume will be lower and the rate of oxidation will be slower. The overall oxidation rate can be controlled by selection of the specific oxidant used, as well as the amount and/or concentration of the oxidant.

In some embodiments, the contaminant may be locally mobilized in a controlled manner, after which the mobilized contaminant may be oxidized. A Winsor Type II system can be locally formed, for example, near a NAPL accumulation zone in the subsurface, and then the emulsion can be broken with an oxidant or other emulsion breaker to make the NAPL more available to react with the oxidant solution. For example, at many LNAPL and DNAPL sites NAPLs may accumulate in sufficient thicknesses that the relative permeability to water in the NAPL accumulation zone is very low and injected chemicals simply pass over, under or around the NAPL accumulation zone, leaving the area untreated. While a Winsor Type I system can increase the rate of solubilization of contaminants of concern (COCs) from the NAPL phase to the aqueous phase, it still may not provide optimal treatment of the site. By creating a localized Winsor Type II or III system, NAPLs may be mobilized more efficiently into subsurface zones where they are more available to and have greater contact with chemicals injected into the aqueous phase. In some cases, it is preferable to employ a sequential treatment of NAPL using first a Winsor Type II or III system to temporarily mobilize NAPL, and then break the Winsor Type II or III system with a breaker or oxidant, to create, for example, a Winsor Type I system. Such a procedure enables an increased rate of solubilization over that achievable with a Winsor Type I system alone.

As used herein, “minimal mobilization” encompasses circumstances in which NAPL may move through colloidal transport but bulk (macroscopic) movement of NAPL downward or horizontal does not occur.

In some embodiments, an amount of surfactant or surfactant-cosolvent mixture is introduced into a subsurface, for example, soil or groundwater, including a contaminant, for example, a NAPL, to form a Winsor Type III system, that is, a middle phase microemulsion. Such a Winsor Type III system can mobilize a contaminant phase, for example, a NAPL phase, in the microemulsion. For example, when the NAPL content of soil in a subsurface is low, a Winsor Type III middle phase microemulsion can be formed to mobilize the NAPL into a bulk pore space and then oxidize the emulsified NAPL in the bulk pore space, for example, by chemical oxidation.

“Introduce” means to cause to be present in a location. The composition can be introduced by pouring, spraying, pumping, or delivering to a surface or material by other means. A substance or composition can be introduced into a location even if the substance or composition is released somewhere else and must travel some distance in order to reach the location. For example, if a substance is released at location A, and the substance will migrate over time to location B, the substance has been “introduced” into location B when it is released at location A. A substance can be introduced in any manner known in the art that would be appropriate under the circumstances. A composition, such as, for example, an oxidant and surfactant or surfactant-cosolvent mixture, with any optional activator or other components, that is or can be introduced into a location, can be referred to as an “introduced composition.”

The surfactant or surfactant-cosolvent mixture can be introduced sequentially or simultaneously (together) into a subsurface. For example, the surfactant or surfactant-cosolvent mixture can first be introduced, then the oxidant can be introduced. Alternatively, the oxidant can first be introduced, then the surfactant or surfactant-cosolvent mixture can be introduced. Alternatively, the oxidant and the surfactant or surfactant-cosolvent mixture can be introduced simultaneously. “Simultaneously” can mean that the oxidant and the surfactant and/or cosolvent are introduced within 6 months of each other, within 2 months of each other, within 1 month of each other, within 1 week of each other, within 1 day of each other, within one hour of each other, or together, for example, as a mixture of oxidant with surfactant and/or cosolvent. In each case, the oxidant is present in sufficient amounts at the right time, together with the surfactant, to oxidize contaminants as they are solubilized or mobilized by a surfactant or cosolvent-surfactant mixture. The introduced compositions, such as oxidant, surfactant, activator, cosolvent, and salts, can be introduced into the subsurface in the solid phase. For example, the location where the compositions are introduced can be selected so that groundwater can dissolve the introduced compositions and convey them to the contaminant location. The introduced compositions can also be introduced into the subsurface as an aqueous solution or aqueous solutions. In addition, some compositions can be introduced in the solid phase and some can be introduced in aqueous solution.

In some embodiments, the contaminated zone to be treated can be located in the subsurface. Alternatively, the contaminated zone to be treated can be above ground, for example, in treatment cells, tanks, windrows, or other above-ground treatment configurations.

In some embodiments, the introduced compositions may be applied to the subsurface using injection wells, point injection systems such as direct push or other hydraulic or percussion methods, trenches, ditches, and by using manual or automated methods.

The subsurface can include any and all materials below the surface of the ground, for example, groundwater, soils, rock, man-made structures, naturally occurring or man-made contaminants, waste materials, or products. Knowledge of the distribution of hydraulic conductivity in the soil and other physical hydrogeological subsurface properties, such as hydraulic gradient, saturated thickness, soil heterogeneity, and soil type is desirable to determine the relative contribution of downward vertical density-driven flow versus normal advection in the subsurface.

Field applications of S-ISCO™ technologies at sites with organic contaminants in either or both of the LNAPL and DNAPL phases, or with sorbed phases, depend on several factors for successful removal of the NAPL or sorbed phases. These factors can include the following.

1) Effective delivery of injected oxidants, activating solutions and surfactants or surfactant-cosolvent mixture into the subsurface.

2) Travel of oxidant, activator, and surfactant solutions to the desired treatment interval in the soil.

3) Selection of surfactants or cosolvent-surfactant mixtures and oxidants to ensure coelution of the surfactants or cosolvent-surfactant mixtures and oxidants, enabling travel of the injected species to the desired treatment interval in the soil.

4) Desorption and apparent solubilization of residual NAPL phases into the aqueous phase for destruction by the oxidant and radical species.

5) Reactions of oxidant and radical species with target mobilized contaminants of concern (COCs).

6) Production of by-products from oxidation and any other injected solutions, including organic or metal species that are below concentrations of regulatory thresholds.

7) Oxidation or natural or enhanced biodegradation of the surfactant or surfactant-cosolvent mixture.

8) Adequate monitoring of COCs, injected oxidant and activator solutions, essential geochemical parameters and any other environmental media potentially affected by the treatment.

The method of using S-ISCO™ technology may involve separate screening and testing of the surfactant and cosolvents, separate testing of optimal oxidant (to meet site needs) and then testing the compositions together. This work can be done in the laboratory environment or in a combination of the laboratory environment and during field testing. This method can involve collecting site soils and groundwater samples that are representative of the highly contaminated soils targeted for S-ISCO™ treatment. In some cases it may be desirable to add NAPL from the site to the test soils. One objective of this step is to provide information concerning potential remedies for a range of soil contaminant conditions, including conditions approaching the most contaminated on the site.

Surfactant or surfactant-cosolvent mixtures to solubilize NAPL components and desorb contaminants of concern (COCs) from site soils or from NAPL in water mixtures can be screened for use in a combined surfactant-oxidant treatment. Blends of biodegradable citrus-based solvents (for example, d-limonene) and degradable surfactants derived from natural oils and products can be used.

For example, a composition of surfactant and cosolvent can include at least one citrus terpene and at least one surfactant. A citrus terpene may be, for example, CAS No. 94266-47-4, citrus peels extract (citrus spp.), citrus extract, Curacao peel extract (Citrus aurantium L.), EINECS No. 304-454-3, FEMA No. 2318, or FEMA No. 2344. A surfactant may be a nonionic surfactant. For example, a surfactant may be an oil or fatty acid, such as ethoxylated castor oil, an ethoxylated coconut fatty acid, or an amidified, ethoxylated coconut fatty acid. An ethoxylated castor oil can include, for example, a polyoxyethylene (20) castor oil, CAS No. 61791-12-6, PEG (polyethylene glycol)-10 castor oil, PEG-20 castor oil, PEG-3 castor oil, PEG-40 castor oil, PEG-50 castor oil, PEG-60 castor oil, POE (polyoxyethylene) (10) castor oil, POE(20) castor oil; POE (20) castor oil (ether, ester); POE(3) castor oil, POE(40) castor oil, POE(50) castor oil, POE(60) castor oil, or polyoxyethylene (20) castor oil (ether, ester). An ethoxylated coconut fatty acid can include, for example, CAS No. 39287-84-8, CAS No. 61791-29-5, CAS No. 68921-12-O, CAS No. 8051-46-5, CAS No. 8051-92-1, ethoxylated coconut fatty acid, polyethylene glycol ester of coconut fatty acid, ethoxylated coconut oil acid, polyethylene glycol monoester of coconut oil fatty acid, ethoxylated coco fatty acid, PEG-15 cocoate, PEG-5 cocoate, PEG-8 cocoate, polyethylene glycol (15) monococoate, polyethylene glycol (5) monococoate, polyethylene glycol 400 monococoate, polyethylene glycol monococonut ester, monococonate polyethylene glycol, monococonut oil fatty acid ester of polyethylene glycol, polyoxyethylene (15) monococoate, polyoxyethylene (5) monococoate, or polyoxyethylene (8) monococoate. An amidified, ethoxylated coconut fatty acid can include, for example, CAS No. 61791-08-0, ethoxylated reaction products of coco fatty acids with ethanolamine, PEG-11 cocamide, PEG-20 cocamide, PEG-3 cocamide, PEG-5 cocamide, PEG-6 cocamide, PEG-7 cocamide, polyethylene glycol (11) coconut amide, polyethylene glycol (3) coconut amide, polyethylene glycol (5) coconut amide, polyethylene glycol (7) coconut amide, polyethylene glycol 1000 coconut amide, polyethylene glycol 300 coconut amide, polyoxyethylene (11) coconut amide, polyoxyethylene (20) coconut amide, polyoxyethylene (3) coconut amide, polyoxyethylene (5) coconut amide, polyoxyethylene (6) coconut amide, or polyoxyethylene (7) coconut amide. The surfactant can be, for example, one or more of ALFOTERRA 123-8S, ALFOTERRA 145-8S, ALFOTERRA L167-7S, ETHOX HCO-5, ETHOX HCO-25, ETHOX CO-40, ETHOX ML-5, ETHAL LA-4, AG-6202, AG-6206, ETHOX CO-36, ETHOX CO-81, ETHOX CO-25, ETHOX TO-16, ETHSORBOX L-20, ETHOX MO-14, S-MAZ 80K, T-MAZ 60 K 60, TERGITOL L-64, DOWFAX 8390, ALFOTERRA L167-4S, ALFOTERRA L123-4S, and ALFOTERRA L145-4S. The surfactant can be or be derived from, for example, one or more of castor oil, cocoa oil, cocoa butter, coconut oil, soy oil, tallow oil, cotton seed oil, a naturally occurring plant oil and a plant extract. The surfactant can be, for example, one or more of an alkyl polyglucoside or an alkyl polyglucoside-based surfactant, a decyl polyglucoside or an alkyl decylpolyglucoside-based surfactant. The surfactant can be, for example, one or more of VeruSOL-1, VeruSOL-2, VeruSOL-3, VeruSOL-4, VeruSOL-5, VeruSOL-6, Citrus Burst 1, Citrus Burst 2, Citrus Burst 3, E-Z Mulse, and combinations. The surfactant can be one that is resistant to breakdown by an oxidant, for example, peroxide. For example, the surfactant can be one that is essentially free of alcohol or alkyl groups, which can render a surfactant more prone to degradation by an oxidant such as, for example, peroxide than is a surfactant that is fatty acid-based. A “plant-derived surfactant” can refer to a composition comprising any one or more of the preceding surfactants and/or, optionally, cosolvents. Furthermore, “plant-derived surfactant” encompasses compositions comprising additional ingredients that enable or enhance the product's cleaning, solubilizing, and/or stabilizing effects. That is, “plant-derived surfactants” can be essentially pure surfactant compositions, or they can comprise a complex array of additional ingredients. VeruSOL surfactants are available from VeruTEK, Inc. ALFOTERRA surfactants are available from Sasol North America. Citrus Burst surfactants are available from Florida Chemical. Ethox, Ethal, and Ethsorbox surfactants are available from Ethox Chemicals. S-Maz and T-Maz surfactants are available from BASF. Tergitol and DOWFAX are available from Dow Chemicals.

Aqueous phase screening can be used to select appropriate oxidants, with and without activators or cosolvents, for the destruction of selected COCs in groundwater collected from the site. As used herein, “activator” means a chemical compound, or a physical property, characteristic or phenomenon, that increases the rate or hastens the progress of a chemical reaction. The activator may or may not be transformed during the chemical reaction that it hastens. An activator can, for example, promote the formation of free radicals in a composition. For example, an activator can react with an oxidant species so as to convert the oxidant to a free radical form. Examples of physical properties, characteristics or phenomena that can serve as activators include, for example, heat, temperature, or a change in pH (e.g., an increase in pH). Examples of chemical compound activators include a metal, iron, Fe(II), Fe(III), a metal chelate, a transition metal chelate, an iron chelate, iron-EDTA, Fe(II)-EDTA, Fe(III)-EDTA, iron-citric acid, Fe(II)-citric acid, Fe(III)-citric acid, and zero valent iron, such as nanoscale zero valent iron (e.g., zero valent iron particles having a diameter in the range of from about 1, 2, 5, 10, 20, 50, 100, 200, or 500 nm to about 2, 5, 10, 20, 50, 100, 200, 500, or 1000 nm). The activator can also be, for example, an alkali metal EDTA compound, such as sodium EDTA.

A catalyst is a substance that increases or hastens the rate of a chemical reaction, but which is not physically or chemically changed during the reaction. For example, persulfate, e.g., sodium persulfate, can be used as an oxidant/catalyst in the compositions and methods disclosed herein. Attributed to its relatively high stability under normal subsurface conditions, persulfate more effectively travels through the subsurface into the target contaminant zone, in comparison to hydrogen peroxide associated with Fenton's or Modified Fenton's Chemistry. Other oxidants include ozone and permanganate, percarbonates, hydrogen peroxide, and various hydrogen peroxide or Fenton's Reagent mixtures. A control system should be run to compare the treatment conditions to those with no treatment. Additionally, tests of the stability of the surfactant or surfactant-cosolvent mixture can be necessary to ensure that the oxidant does not immediately, or too quickly, oxidize the surfactant or cosolvent-surfactant mixture rendering it useless for subsequent dissolution.

Non-thermal ISCO using persulfate requires activation by ferrous ions, and/or preferentially chelated metals. Chelated iron has been demonstrated to prolong the activation of persulfate, enabling activation to take place at substantial distances from injection wells.

Several practical sources of Fe(II) or Fe(III) can be considered for activation of persulfate. Iron present in the soil that can be leached by injection of a free-chelate (a chelate not complexed with iron, but instead, for example, Na⁺ and H⁺) can be a source. Injection of soluble iron as part of a chelate complex, such as Fe(II)-EDTA, Fe(II)-NTA or Fe(II)-Citric Acid (or another Fe-chelate, such as Fe-EDDS) can be a source. Indigenous dissolved iron resulting from reducing conditions present in the subsurface (common at many MGP sites) can also be a source.

Soil slurry tests can be run on selected combinations of surfactant or surfactant-cosolvent mixtures to determine the solubilization of specific COCs relative to site cleanup criteria. Additionally, soil slurry tests can be run to screen and determine optimal dosing of chemical oxidants for both dosing requirements and COCs treated. Combining enhanced solubilization brought about by surfactants or surfactant-cosolvent mixtures with chemical oxidation is a more aggressive approach that can be used to desorb residual tars, oils, and other NAPLs from the soils, and also simultaneously oxidize the desorbed COCs with the chemical oxidant. A soil slurry control system can be run to compare the treatment conditions with no treatment.

Soil column tests can be run to simulate treatment performance and COC destruction using soil cores obtained from the most highly contaminated soils associated with the proposed surface enhanced in situ chemical oxidation (S-ISCO™) treatment areas of a site. Results from soil column tests can be used to identify the treatment conditions and concentrations of chemicals to be evaluated. The soil column tests can consist of using one oxidant alone or a mixture of oxidants simultaneously with a surfactant or a mixture of surfactants or a cosolvent-surfactant mixture; various configurations or concentrations of oxidants or mixtures of oxidants used alone or simultaneously with a surfactant or a cosolvent-surfactant mixture can be selected based on soil slurry tests. Different activation methods can additionally be tested using soil column testing. By monitoring surfactant concentrations and/or interfacial tension in the effluent of the soil columns, the reactivity of the surfactant and cosolvents with the oxidants can be determined to evaluate the compatibility of particular oxidants with the selected surfactants and cosolvents. COC concentrations in the effluent of the column can be monitored to determine the ability of the oxidant to destroy the cosolvent-surfactant or surfactant micelles or emulsions and react with the COCs.

An example of an oxidant is persulfate, e.g., sodium persulfate, of an activator is Fe(II)-EDTA, of a surfactant is Alfoterra 53, and of a cosolvent-surfactant mixture is a mixture of d-limonene and biodegradable surfactants, for example, Citrus Burst 3. Citrus Burst 3 includes a surfactant blend of ethoxylated monoethanolamides of fatty acids of coconut oil and polyoxyethylene castor oil and d-limonene.

When the S-ISCO™ process according to embodiments of the present invention is complete, the remaining concentration of contaminants is greatly reduced from the initial concentration. The remaining contaminants, whether they reside in the dissolved or in the sorbed phases, are much more readily amenable to natural attenuation processes, including biodegradation.

In some embodiments of S-ISCO™ remediation, a formulation can be introduced into the subsurface above the water table, that is, into the unsaturated or vadose zone. The introduced composition can include cosolvent, surfactant, or a cosolvent/surfactant mixture; an oxidant; and optionally an activator. The density of the introduced composition can be adjusted so as to be less than that of water. Introducing such a composition into the subsurface above the water table can be used to control the volatilization of volatile inorganic and/or organic chemicals from the saturated zone into the unsaturated zone, in order to prevent or minimize the risk of exposing people to vapors of these chemicals.

Examples of cosolvents which preferentially partition into the NAPL phase include higher molecular weight miscible alcohols such as isopropyl and tert-butyl alcohol. Alcohols with a limited aqueous solubility such as butanol, pentanol, hexanol, and heptanol can be blended with the water miscible alcohols to improve the overall phase behavior. Given a sufficiently high initial cosolvent concentration in the aqueous phase (the flooding fluid), large amounts of cosolvent can partition into the NAPL. As a result of this partitioning, the NAPL phase expands, and formerly discontinuous NAPL ganglia can become continuous, and hence mobile. This expanding NAPL phase behavior, along with large interfacial tension reductions, allows the NAPL phase to concentrate at the leading edge of the cosolvent slug, thereby increasing the mobility of the NAPL. Under certain conditions, a highly efficient piston-like displacement of the NAPL is possible. Because the cosolvent also has the effect of increasing the NAPL solubility in the aqueous phase, small fractions of the NAPL which are not mobilized by the above mechanism are dissolved by the cosolvent slug.

The phase behavior of a specific system can be controllable. Laboratory experiments have shown that surfactant/cosolvents that preferentially stay with the aqueous phase can dramatically increase the solubility of NAPL components in the aqueous phase. In cases where the solvent preferentially partitions into the aqueous phase, separate phase NAPL mobilization is not observed, and NAPL removal occurs by enhanced dissolution. Solubilization has the added benefits of increasing bioavailability and the rate of biological degradation of the contaminants.

In some embodiments, the consumption of oxidant can also be controlled by including an antioxidant in the injected solution. For example, an antioxidant can be used to delay the reaction of an oxidant. Such control may prove important when, for example, the injected oxidant must flow through a region of organic matter which is not a contaminant and with which the oxidant should not react. It may be important to avoid oxidizing this non-contaminant organic matter, so as to maximize the efficiency of contaminant elimination by the oxidant. That is, by avoiding oxidant reactions with non-contaminant organic matter, more oxidant remains for reaction with the contaminant. Furthermore, it may also be important to avoid oxidizing non-contaminant organic matter because, for example, topsoil or compost may be desirable organic matter in or on soil, and thus should be retained. The anti-oxidants used may be natural compounds or derivatives of natural compounds. Using such natural antioxidants, their isomers, and/or their derivatives can minimize the impact on the environment. Also, for example, natural processes in the environment may degrade and eliminate natural antioxidants, so that they do not then burden the environment. The use of natural antioxidants is consistent with the approach of using biodegradable surfactants, cosolvents, and solvents. An example of a natural antioxidant is a flavonoid. Examples of flavonoids include, for example, quercetin, glabridin, red clover, and Isoflavin Beta (a mixture of isoflavones available from Campinas of Sao Paulo, Brazil). Other examples of natural antioxidants that can be used in the disclosed methods of soil remediation include beta carotene, ascorbic acid (vitamin C) and tocopherol (vitamin E), as well as their isomers and/or derivatives. Non-naturally occurring antioxidants, such as beta hydroxy toluene (BHT) and beta hydroxy anisole (BHA), can also be used.

In some embodiments, a plant-derived surfactant can be included in the injected solution instead of or in addition to an antioxidant, to delay the reaction of an oxidant, the rate of decomposition of an oxidant, and/or the rate of radical formation from the oxidant.

Citrus Burst 1, Citrus Burst 2, Citrus Burst 3, and E-Z Mulse are manufactured by Florida Chemical.

The VeruSOL™ solvents can include plant derived surfactants. For example, a VeruSOL™ solvent can include the citrus terpene bearing CAS#94266-47-4 in a concentration of from about 10 to about 40%, the nonionic surfactant CAS#61791-12-6 in a concentration of from about 10 to about 40%, the nonionic surfactant CAS#61791-29-5 in a concentration of from about 10 to about 40%, and the nonionic surfactant CAS#61791-08-0 in a concentration of from about 10 to about 40%.

In many industrial applications, the faster the catalysis of an oxidant, such as peroxide and persulfate, the better. However, the catalysis of peroxide and persulfate in subsurface remediation applications is often most effectively conducted at a controlled rate, and in many cases as slow as possible while still maintaining effective catalysis. Decreased rates of catalysis can be achieved using plant extract and plant extract-based surfactants, and the rate can be measured using bromothymol blue as a probe compound. Inclusion of plant extracts can reduce the rate of catalysis to, for example, 90%, 75%, 50%, 25%, 10%, 5%, 1% or less, compared to the rate without plant extract-containing catalysts. In terms of initial rate constants, the plant extract-controlled catalysts may decrease the initial rate constant to 0.2/min, 0.1/min, 0.05/min, 0.01/min, 0.005/min or otherwise as described for a particular application.

As used herein, the term “surfactant” includes, for example, compounds known in the art as cosolvents, as well as compounds known in the art as surfactants, and combinations.

In some embodiments, a plant-derived surfactant, for example an extract of a plant or a subsequently chemically-modified extract of a plant, can act to slow or stop the radicalization of an oxidant, for example by action of an activator. For example, the plant-derived surfactant can act to reduce the rate of formation of free radicals from the action of an activator on an oxidant to a predetermined, user-selected rate.

An activator can be a physical state or parameter, a form of energy, and/or a chemical compound. For example, a metal, a chelated metal, Fe(II)-EDTA, Fe(III)-EDTA, and Na-EDTA can serve as activators that induce the formation of radical species from an oxidant, such as a peroxide or a persulfate. For example, a condition such as elevated pH, for example, a pH greater that about 7, 8, 9, 10, 11, or 12 can serve as an activator. For example, elevated temperature, heat, or radiation, such as ultraviolet or visible light radiation can serve as an activator. Combinations of chemical compounds; combinations of physical states, physical parameters, and energies (such as forms of radiation); as well as combinations of chemical compounds with physical states, physical parameters, and/or energies can serve as activators. Some oxidants, such as, for example, hydrogen peroxide, can become unstable at elevated temperatures, such as, for example, 30-40° C.

A threshold concentration may exist for a plant-derived surfactant to act to inhibit the formation of radical species, for example, that result from the action of an activator on an oxidant. For example, a concentration of at least about 0.1, 0.25, 0.5, 1, 2, 3, 5, 10, 20, 50, 100 g/L, or greater of plant-derived surfactant may be required to inhibit the formation of radical species. A minimum threshold ratio of the concentration of plant-derived surfactant to the concentration of oxidant may be required to inhibit the formation of radical species. For example, the ratio of the concentration of plant-derived surfactant to the concentration of oxidant (when concentrations are expressed as mass per volume) can be at least about 1%, 2%, 5%, 10%, 20%, 25%, 50%, 100%, 200%, 300%, 400% or more. That is, the ratio of the concentration of plant-derived surfactant to the concentration of oxidant can be about 1:100, 1:50, 1:20, 1:10, 1:5, 1:4, 1:2, 1:1, 2:1, 3:1, 4:1 or more. Based on the surfactant concentrations and the above-described surfactant/oxidant ratios, a person of ordinary skill in the art would readily be able to determine oxidant concentrations, which can be, for example, up to or at least about 1%, 2%, 3%, 3.9%, 4%, 5%, 6%, 7%, 8%, 9%, 10%, 12%, 20%, 30%, 40%, 50% or more; or about 1% to about 50%; about 1% to about 12%; about 1% to about 10%, about 1% to about 8%, or about 1% to about 4%, of an oxidant. The oxidant can be, for example, peroxide or hydrogen peroxide. Peroxide concentration can be measured in a variety of ways, for example using a permanganate titration method.

A minimum threshold ratio of the concentration of plant-derived surfactant to the concentration of a chemical activator (if one is present) may be required to inhibit the formation of radical species. For example, the ratio of the concentration of plant-derived surfactant to the concentration of activator (when concentrations are expressed as mass per volume) can be at least about 1 time, 2 times, 5 times, 10 times, 13 times, 20 times, 50 times, or 100 times. The compositions can have either high, moderate, or low viscosity. For example, the viscosity can be up to or at least about 10 cps, 25 cps, 50 cps, 60 cps, 100 cps, 200 cps, 300 cps, 400 cps, 500 cps, 1000 cps, 1500 cps, 2000 cps, 2500 cps, 3000 cps, 6000 cps, 10,000 cps or more.

The compositions disclosed herein provide many desirable characteristics. They can be free or essentially free of anionic surfactants, and can provide a decreased level of foaming action and better rinsability versus that observed with, for example, many anionic surfactants. Furthermore, the compositions can be characterized in that they do not cause eye irritation. Many anionic surfactants can react with oxidants such as, e.g., hydrogen peroxide, thus causing loss of oxidant over time. The compositions can have a pH less than about 7, or less than about 6.9, or less than about 6.8, or less than about 6.7, or less than about 6.6, or less than about 6.5, or less than about 6, or less than about 5.5, or less than about 5; or they can have a pH in the range of about 4 to about 8, or about 4 to about 7, or about 4 to about 635, or about 4 to about 6.5, or about 6.5 to about 7.5. They can be neutral, non-alkaline, or slightly acidic. The compositions can be particularly useful in cleaning contaminants on surfaces, such as grease and grime found in, for example, an auto repair shop or a factory, or in heavy grease cleaning applications, for example in restaurants. The compositions can be particularly effective against contaminants with a high content of organics, for example those with high oil content.

The inventive oxidant/surfactant compositions disclosed herein exhibit surprising characteristics and can work in synergistic fashion in reducing contaminant levels. For example, the plant-derived surfactants disclosed herein, for example when employed in the concentration and surfactant/oxidant ratios disclosed herein, can be resistant to degradation by an oxidant, such as, for example, hydrogen peroxide. Accordingly, the surfactants can be stable over long periods—e.g., up to or at least about 1 week, 2 weeks, 1 month, 2 months, 3 months, 6 months, 7 months, 1 year or longer—in the presence of an oxidant. Similarly, the oxidants, such as, for example, hydrogen peroxide, can be resistant to decomposition when included in a composition containing a plant-derived surfactant, for example when employed in the concentration and surfactant/oxidant ratios disclosed herein. As a result, the oxidants can be stable over long periods—e.g., up to or at least about 1 week, 2 weeks, 1 month, 2 months, 3 months, 6 months, 7 months, 1 year or longer—and can also be preserved so that they can act primarily against the contaminants, and not react, for example, with the surfactant or surfactant-cosolvent component in the formulation, or with extraneous or non-contaminant chemicals in the medium (e.g., a subsurface or a surface to be cleaned). The surfactant and oxidant can also work synergistically. For example, the surfactant can act to solubilize contaminants, thus facilitating the process of degradation of the contaminants by an oxidant such as peroxide. And because both the surfactant and oxidant can be preserved in the compositions disclosed herein, these synergistic activities can be enhanced, thus increasing the cleaning, remediating and/or contaminant-reducing effects of the compositions disclosed herein.

The compositions disclosed herein can exhibit high oxidant stability, for example high peroxide stability, with or without the use of stabilizers and other agents used in the art to bring about stability of an oxidant such as peroxide. For example, the compositions can be free, or essentially free, of one or more of the following: pyrophosphates; carboxyvinyl polymers; anionic surfactants; sulphonated hydrotropes; zwitterionic betaine surfactants; synthetic surfactants; fatty alcohol sulfates; alkyl polyglucosides; and fatty acid sarcosinates; alkali metal salts; alkyl sulfonates; and/or thickeners. The compositions disclosed herein can be free or essentially free of compounds that cause degradation of the surfactants used in the disclosed compositions, and/or of those that cause decomposition of an oxidant such as, for example, hydrogen peroxide. As used herein, “essentially free” means that the referenced ingredient or characteristic is present in an amount less than is generally used in order to perform a function normally ascribed to the ingredient or characteristic by a person of ordinary skill. For example, a composition is “essentially free” of one or more of the above-listed ingredients if the ingredient is below the level generally used to achieve stabilization of a surfactant or an oxidant such as peroxide in compositions similar to those disclosed here. E.g., a composition can be “essentially free” of an ingredient if that ingredient is included in an amount less than about, for example, 10%, 5%, 2.5%, 1%, 0.5%, 0.01%, 0.005%, 0.001%, 0.0005%, or 0.0001% of the composition.

In a method according to some embodiments, the rate of formation of radicals in an aqueous mixture of an oxidant, an activator, and water can be reduced by adding a plant-derived surfactant to the mixture. The plant-derived surfactant can be added at a predetermined concentration in the mixture. The plant-derived surfactant can reduce the rate of formation of radicals. For example, the plant-derived surfactant can reduce the rate of formation of radicals to a predetermined rate. The predetermined rate of radical formation can be an absolute rate, e.g., moles of radicals produced per second per liter of mixture. Alternatively, the predetermined rate of radical formation can be defined in terms of another quantity, for example, in terms of the decomposition of a probe compound that is degraded by radicals formed. For example, the predetermined rate of radical formation can be defined in terms of the rate of decrease in concentration of a sulfophthalein dye, such as bromothymol blue, for example, as parts per million weight (ppm) of dye in the solution per second. For example, the predetermined rate of radical formation upon addition of plant-derived surfactant can be such that a sulfophthalein dye compound introduced at a first concentration when forming the mixture has a second concentration 24 hours after forming the mixture. The second concentration after 24 hours of reaction can be, for example, at least about 50%, 80%, 90%, 95%, 98%, 99%, 99.5%, or 99.9% of the first, initial concentration of sulfophthalein dye.

In some embodiments, a plant-derived surfactant can be added to an aqueous mixture of an oxidant and an optional activator prior to storage or transport of the solution of the oxidant and activator, so as to stabilize the oxidant against decomposition and free radical formation. The compositions disclosed herein can exist in a container for, e.g., shipping, or they can be formed in situ.

Peroxides are unstable during preparation, storage, handling, and use, and readily decompose to oxygen and water, or via a free radical pathway. Stabilization of peroxide generally requires use of chemical and physical means to stabilize the peroxide and prevent its decomposition. Stabilization systems may include opaque containers to prevent contact with light, cool storage to avoid thermal decomposition, (including vented containers to avoid buildup of oxygen gas), a neutral to slightly acid pH to avoid alkali decomposition, dilution with water to avoid increased decomposition that occurs at high concentrations, high purity to avoid the presence of iron, magnesium, calcium, and transition metals and other impurities that catalyze or react with peroxide to cause it to decompose, and the addition of chemical stabilizers. For example, commercial grades of hydrogen peroxide generally contain chelators and/or sequestrants, especially tin and phosphate compounds such as colloidal stannates, sodium pyrophosphate, and organophosphonates (e.g. at 25-250 mg/L), and pH adjusters like nitrate or phosphoric acid. Sequestrants may include colloidal silicate in alkali conditions. The effectiveness of various combinations of stabilizers in preventing peroxide decomposition is somewhat unpredictable and depends on the overall content of a peroxide formulation, and the formulation contents may vary widely to accomplish different objectives.

The compositions disclosed herein can be storage stable. As used herein, a “storage stable” composition is one whose effectiveness remains within an acceptable range over a defined period of time, such as, for example, the composition's shelf life. The disclosed compositions can be storage stable for up to or at least about, for example, 3 days, 1 week, 2 weeks, 1 month, 3 months, 6 months, 9 months, 1 year or more. For example, the compositions disclosed herein are “storage stable” during and after synthesis of the components; during and after preparation of the composition from the components; before, or in lieu of, the addition of other stabilizing agents to the composition; during and after dilution, if applicable; during and after shipping; during and after formulation into a ready-to-use composition, if applicable; during storage and/or display at a commercial or retail facility; and before and after storage while in a consumer's possession, if applicable. The concentrations of the components, e.g., the surfactant and/or the oxidant, may vary during this period, but, notwithstanding this variation, the compositions when used retain acceptable performance characteristics.

The inventive compositions, particularly those containing peroxides, can include ingredients, such as sodium stannate and phosphonic acid, that contribute to the overall stability of the composition, whether or not they contribute to the stability of the oxidant itself. Because of the stability afforded by the combinations of surfactants and oxidants, for example peroxide, disclosed herein, the levels of tin- and phosphorus-containing chemicals can be lower than found in other compositions. For example, the compositions disclosed herein can have a maximum tin and phosphorus contents as low as, or lower than, those found in hydrogen peroxide preparations for industrial applications. Tin and phosphorous based hydrogen peroxide stabilizing agents commonly sold in hydrogen peroxide preparations are not needed in these plant oil based surfactant stabilized systems, even though such inorganic stabilizing agents are almost always present in commercially used hydrogen peroxide products to decrease hydrogen peroxide decomposition in the storage and shipping or hydrogen peroxide. The compositions disclosed herein can be stable without any tin or phosphorus based hydrogen peroxide stabilizing agents added over that included in commercially used hydrogen peroxide products. For example, the compositions disclosed herein can have stannate stabilizers in an amount less than about 1, 5 mg/L as tin, less than about 10 mg/L as tin, less than about 25 mg/L as tin, less than about 50 mg/L as tin, less than about 100 mg/L as tin, less than about 150 mg/L as tin, less than about 200 mg/L as tin, less than about 250 mg/L as tin, less than about 500 mg/L as tin, or less than about 1000 mg/L as tin. For example, the compositions disclosed herein can have stannate stabilizers in an amount less than about 1 ppm, less than about 5 ppm, less than about 10 ppm, less than about 25 ppm, less than about 50 ppm, less than about 100 ppm, less than about 150 ppm, less than about 200 ppm, less than about 500 ppm, or less than about 1000 ppm. For example, the compositions disclosed herein can have phosphorus based stabilizers in an amount less than about 0.001 percent of the hydrogen peroxide concentration, or less than about 0.0025 percent of the hydrogen peroxide concentration, or less than about 0.01 percent of the hydrogen peroxide concentration, less than about 0.025 percent of the hydrogen peroxide concentration, less than about 0.05 percent of the hydrogen peroxide concentration, less than about 0.075 percent of the hydrogen peroxide concentration, less than about 0.1 percent of the hydrogen peroxide concentration, or less than about 0.2 percent of the hydrogen peroxide concentration; or less than about 1 ppm, less than about 5 ppm, less than about 10 ppm, less than about 25 ppm, less than about 50 ppm, or less than about 100 ppm, less than about 150 ppm, less than about 200 ppm, less than about 500 ppm, or less than about 1000 ppm. According to the invention, such stabilizer components are not required, but their presence may be inevitable depending on the source and supply of hydrogen peroxide used to formulate the inventive compositions. Thus, the inventive compositions may have no added tin or phosphorous based stabilizer beyond the amount provided with the hydrogen peroxide stock material.

In some embodiments, a plant-derived surfactant is added to an aqueous mixture of an oxidant and an activator prior to injection of the mixture into a subsurface, a wastewater stream, or another location, such as an above-ground dump site. The addition of the plant-derived surfactant can be used to tailor the rate of radical formation to a desired rate, so as to optimize the destruction of undesirable contaminant chemicals. For example, the plant-derived surfactant can be added so as to delay the decomposition of oxidant injected into a subsurface, so that the oxidant may be conveyed by groundwater flow to a site where contaminant resides, for the purpose of ensuring that sufficient oxidant arrives at the contaminant so as to effectively destroy the contaminant.

In some embodiments, a plant-derived surfactant can be injected into a subsurface containing a soil, a wastewater stream, or another quantity of material, such as an above-ground dump site separately from an oxidant and an activator for the purpose of decreasing the rate of decomposition of the oxidant. For example, the plant-derived surfactant can mix with the oxidant within the soil, wastewater, or other material to decreasing the rate of rate of radical formation and decrease the rate of decomposition of the oxidant.

In some embodiments, a plant-derived surfactant can be added to an oxidant solution, for example, an aqueous solution of hydrogen peroxide and/or sodium persulfate, prior to shipment, storage, or pumping of the oxidant in a liquid phase, so as to increase the stability of the oxidant in the liquid phase during shipment, storage, or pumping. For example, the plant-derived surfactant can slow or stop decomposition of the oxidant induced by the presence of iron particles, iron ions, or iron radicals in the liquid phase, for example, in water.

In some embodiments, a plant-derived surfactant can be added to an oxidant solution prior to storage of the oxidant so as to increase the stability of the oxidant in the liquid phase during storage. The resulting compositions can be packaged in, for example, a container suitable for shipment to a remediation site, such as, for example, in a storage tank or drum or vessel that can hold about 5, 10, 15, 20, 25, 30, 35, 40, 50, 55, 75, 100, 150 or 200 gallons or more. The compositions can be packaged in a smaller container suitable for wholesale or retail sale to consumers, e.g. in a 10 ml, 50 ml, 100 ml, 250 ml, 500 ml, 1 liter, 2 liters, a half gallon, or gallon size container, e.g., a spray bottle, aerosol can, squeeze-dispense or press-dispense bottle, or any other packaging known in the art.

In some embodiments, a plant-derived surfactant can be added to an oxidant solution prior to shipment or storage of the oxidant-surfactant mixture, so as to eliminate the need for two separate shipments or storage tanks when transporting and delivering the oxidant and surfactant to the treatment site. In addition, where only one container is used, only one pump and piping delivery system is needed to ship, store, process and use the oxidant/surfactant solution.

In some embodiments, the compositions can consist essentially of a surfactant, for example in a concentration of about 10 g/L to about 100 g/L, or about 25 g/L to about 50 g/L; an oxidant such as, for example, peroxide (in an amount of at least about 1%, or from about 1% to about 3.9% or about 1% to about 8%) or persulfate; and optionally a cosolvent such as, for example, a citrus terpene such as d-limonene; and optionally with small amounts of stannate or a phosphonic acid compound previously added to the oxidant prior to formulation with the surfactant. The compositions can consist essentially of an oxidant, surfactant selected from the group consisting of an ethoxylated soybean oil, an ethoxylated castor oil, an ethoxylated coconut fatty acid, an amidified, ethoxylated coconut fatty acid, an alkyl polyglucoside, a decyl polyglucoside and combinations, for example in the amounts disclosed herein.

In some embodiments, the invention provides methods. For example, in one aspect, the invention provides methods for reducing the concentration of a contaminant in or on a medium. These methods can comprise, for example, obtaining a composition disclosed herein; and introducing the composition into or onto the medium, thereby reducing the concentration of contaminant in or on the medium. In another aspect, the invention provides methods for making a composition disclosed herein. These methods can comprise, for example, combining the surfactant and oxidant in a container to make the composition; and storing the composition in the container for a period of time, for example at least about 1 month, or for example for the shelf life of the composition.

The following examples are provided in order to better enable one of ordinary skill in the art to make and use the disclosed compositions and methods, and are not intended to limit the scope of the invention in any way.

### Example 1

### Stabilization with VeruSOL-3™ of Sodium Persulfate Solutions Including Activator

A series of aqueous solutions, in vials I-1 through I-12, were prepared to study the effect of the VeruSOL-3™ plant-derived surfactant on the rate of activator-induced formation of radicals from sodium persulfate oxidant. Bromothymol blue was added to each of the solutions. The Bromothymol blue served as a probe to detect the rate of formation of radicals from the sodium persulfate. The identity and concentrations of components in the solutions is presented in Table 1.

TABLE 1
Contents and conditions used in stability test samples
SP Stabilization Tests

| | | | | | | Fe-EDTA | | |
|---|---|---|---|---|---|---|---|---|
| Sample | | Total | Bromothymol | SP | Na-EDTA | (mg/L as | VeruSOL- | |
| ID | Conditions | Volume | Blue (ppm) | (g/L) | (mg/L) | Fe) | 3 (g/L) | Notes |
| I-1 | unadjusted | 40 mL | 500 | 30 | 407 | — | — | Photographs and UV Scans at 0, 2, 4, 24, |
| | pH | | | | | | | measurements at 0 and 72 |
| I-2 | unadjusted | 40 mL | 500 | 30 | 407 | — | 3 | Photographs and UV Scans at 0, 2, 4, 24, |
| | pH | | | | | | | measurements at 0 and 72 |
| I-3 | unadjusted | 40 mL | 500 | 30 | — | 60 | — | Photographs and UV Scans at 0, 2, 4, 24, |
| | pH | | | | | | | measurements at 0 and 72 |
| I-4 | unadjusted | 40 mL | 500 | 30 | — | 60 | 3 | Photographs and UV Scans at 0, 2, 4, 24, |
| | pH | | | | | | | measurements at 0 and 72 |
| I-5 | pH > 12 | 40 mL | 50 | 30 | — | — | — | Photographs and UV Scans at 0, 2, 4, 24, |
| | | | | | | | | measurements at 0 and 72 |
| I-6 | pH > 12 | 40 mL | 50 | 30 | — | — | 3 | Photographs and UV Scans at 0, 2, 4, 24, |
| | | | | | | | | measurements at 0 and 72 |
| I-7 | pH > 12 | 40 mL | 50 | 30 | — | — | 0 | Photographs and UV Scans at 0, 2, 4, 24, |
| | | | | | | | | measurements at 0 and 72 |
| I-8 | pH > 12 | 40 mL | 50 | 30 | — | — | 5 | Photographs and UV Scans at 0, 2, 4, 24, |
| | | | | | | | | measurements at 0 and 72 |
| I-9 | pH > 12 | 40 mL | 50 | 30 | — | — | 10 | Photographs and UV Scans at 0, 2, 4, 24, |
| | | | | | | | | measurements at 0 and 72 |
| I-10 | pH > 12 | 40 mL | 50 | 30 | — | — | 20 | Photographs and UV Scans at 0, 2, 4, 24, |
| | | | | | | | | measurements at 0 and 72 |
| I-11 | pH > 12 | 40 mL | 50 | 0 | — | — | 20 | Photographs and UV Scans at 0, 2, 4, 24, |
| | | | | | | | | measurements at 0 and 72 |
| I-12 | unadjusted | 40 mL | 500 | 30 | — | — | 0 | Photographs and UV Scans at 0, 2, 4, 24, |
| | pH | | | | | | | measurements at 0 and 72 |

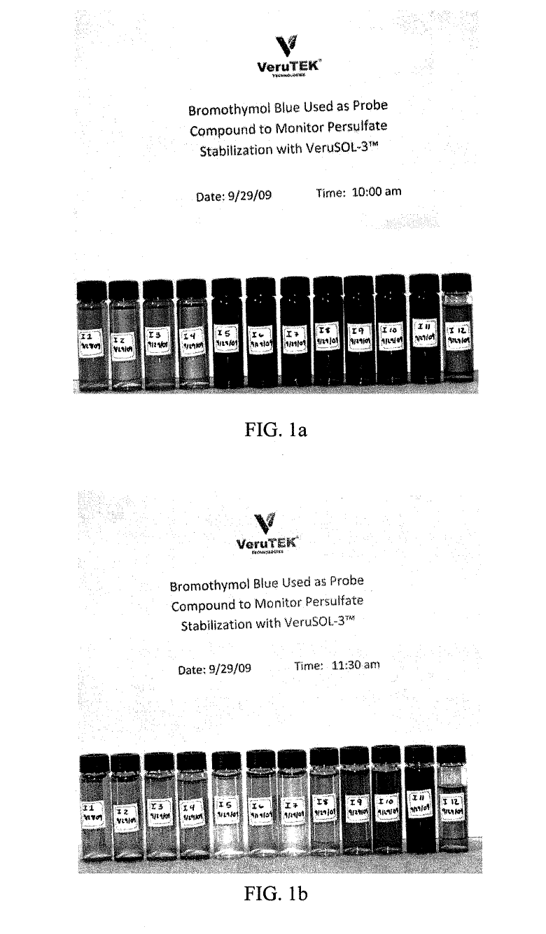

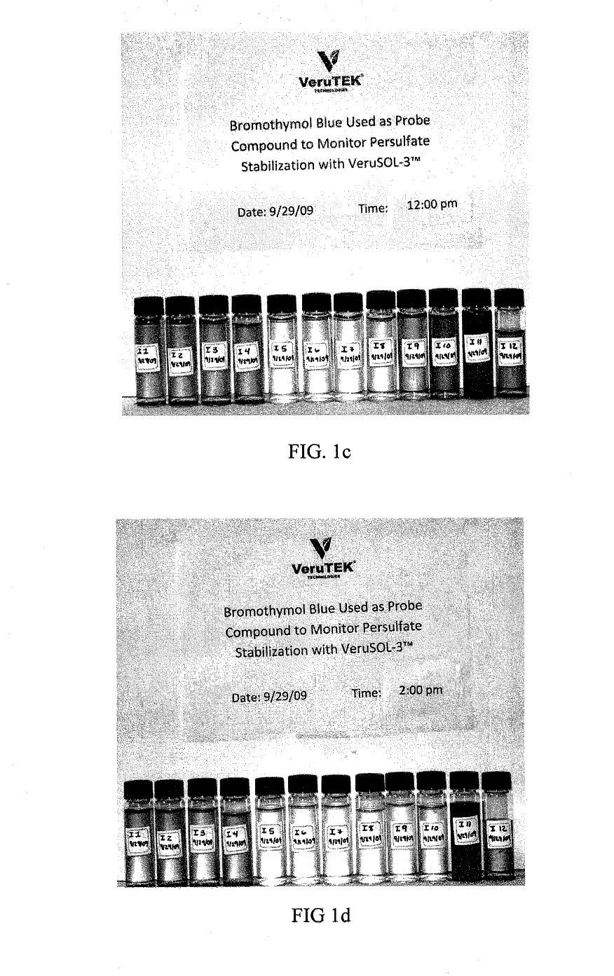

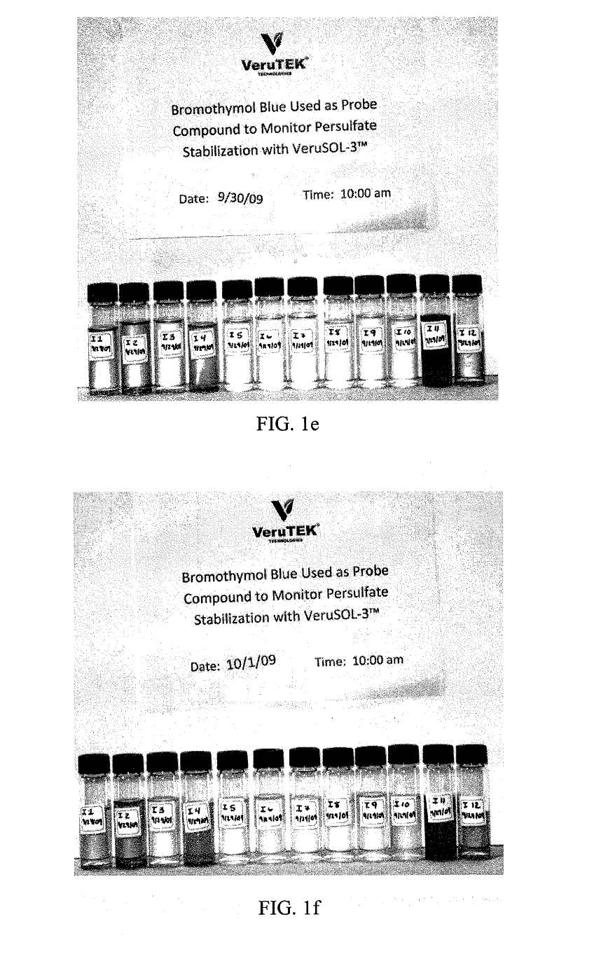

FIG. 1 presents photographs of vials I-1 through I-12 at times of 0, 1.5, 2, 4, 24, and 72 hours following composition of the solutions in the vials. In FIG. 1a, vials I-1 through I-4 and I-12 are orange, and vials I-5 through I-11 are blue. In FIG. 1b, vials I-1 through I-4 are orange, vials I-5 and I-7 are clear, vial I-6 is green, vial I-8 is light blue, vials I-9 and I-10 are blue, vial I-11 is dark blue, and vial I-12 is orange. In FIG. 1c, vials I-1 through I-4 are orange, vials I-5 and I-7 are clear, vials I-6 is light green, vial I-8 is green, vial I-9 is light blue, vial I-10 is blue, vial I-11 is dark blue, and vial I-12 is orange. In FIG. 1d, vials I-1 through I-4 are orange, vials I-5 through I-9 are clear, vial I-10 is light green, vial I-11 is dark blue, and vial I-12 is orange. In FIG. 1e, vials I-1, I-2, I-4 and I-12 are orange, I-3 is yellow, vials I-5 through I-10 are clear, and vial I-11 is dark blue. In FIG. 1f, vials I-1, I-2, I-4 and I-12 are orange, I-3 and I-5 through I-10 are clear, and vial I-11 is dark blue.

The first two samples from the left are the Na-EDTA with and without VeruSOL-3. The second sample from left, I-2, which included VeruSOL exhibited less of a color change over time than did the first sample at left, I-1, which did not include VeruSOL. While there was understood to be only minor production of free radicals with Na-EDTA (as would be expected) the lesser color change observed for vial I-2 indicated that the addition of VeruSOL-3 decreased the rate of radical production further than what would be expected with the chelator. The third and fourth vials from left, I-3 and I-4, included Fe-EDTA which was expected to generate free radicals. The addition of VeruSOL-3 to vial I-4 resulted in a dramatic decrease in the production of free radicals in comparison with vial I-3, to which no VeruSOL-3 was added. Over the course of 72 hours the color of the solution in the I-4 vial exhibited little change, whereas the color of the solution in the I-3 vial changed from orange to clear. Vials I-5 and I-6 included alkaline activated persulfate, without VeruSOL-3 (I-5) and with VeruSOL-3 (I-6). At 1.5 hours following composition, the green color of the solution in vial I-6, which includes VeruSOL-3, indicates that bromothymol blue is still present. By contrast, at 1.5 hours, the solution in vial I-5, which does not include VeruSOL-3, is essentially clear, indicating that essentially no bromothymol blue remains. Vials I-7 through I-10, included alkaline activated persulfate with increasing concentrations of VeruSOL-3. The blue color persisted longer in the vials with a greater concentration of VeruSOL-3, indicating that the greater the concentration of VeruSOL-3, the slower the rate of production of radicals that degraded the bromothymol blue. However, after about 2 hours, little bromothymol blue remained. The solution in vial I-11 contained no persulfate and had pH>12 and, therefore, served as a control. The solution in vial I-11 exhibited no reaction of the bromothymol blue. The solution in vial I-12 included persulfate but no activator, and exhibited little or no reaction of the bromothymol blue over the course of 72 hours.

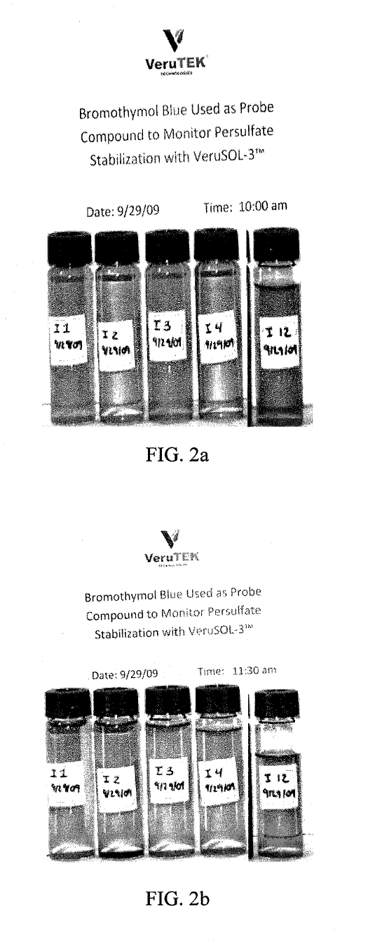

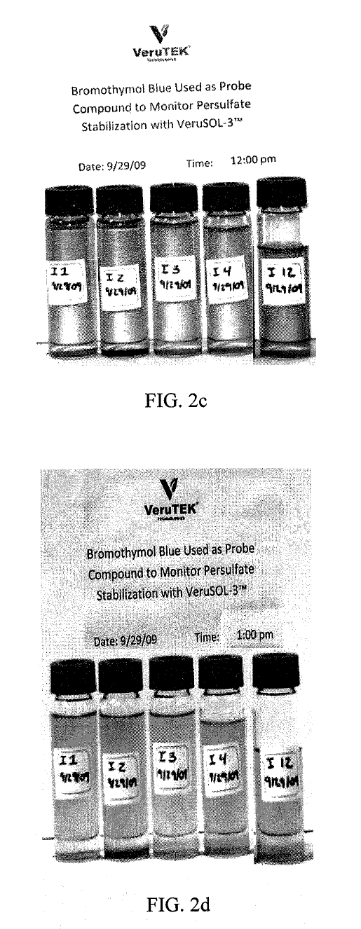

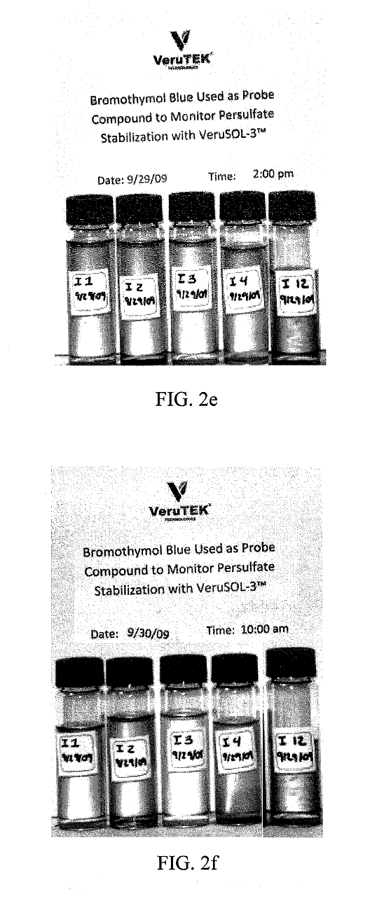

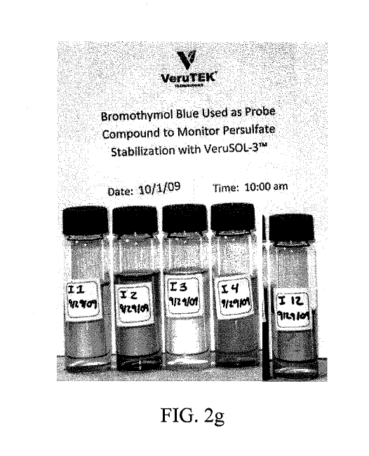

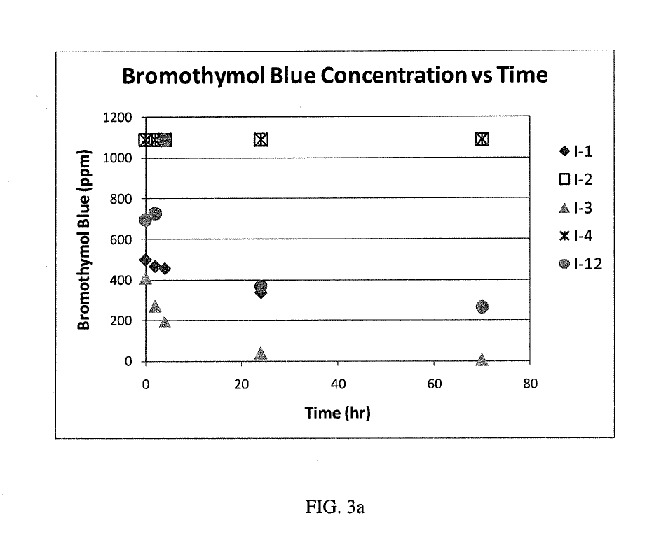

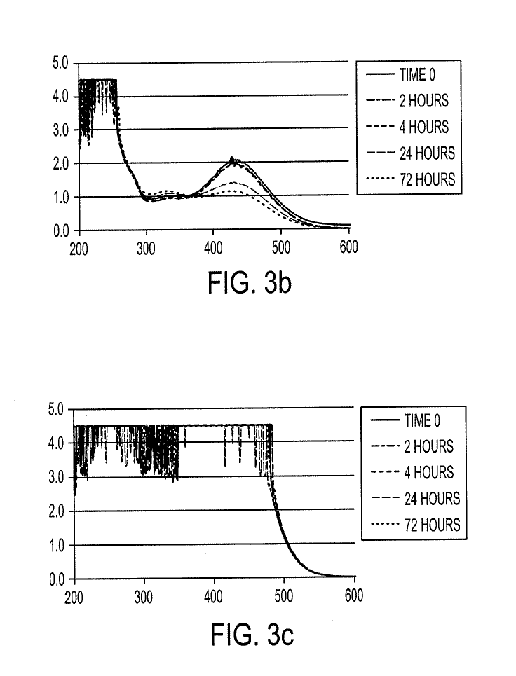

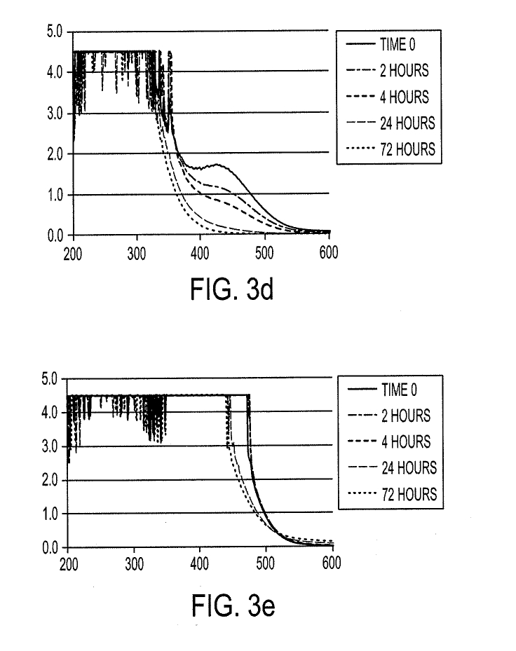

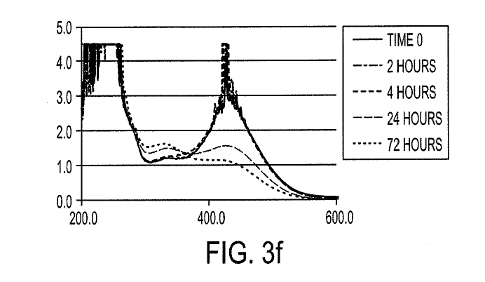

FIG. 2 presents close-up photographs of vials I-1 through I-4 and I-12 at times of 0, 1.5, 2, 3, 4, 24, and 72 hours following composition of the solutions. In FIGS. 2a through 2e, vials I-1 through I-4 and I-12 are orange. In FIG. 2f, vials I-1, I-2, I-4 and I-12 are orange and I-3 is yellow. In FIG. 2g, vials I-1, I-2, I-4 and I-12 are orange and I-3 is clear.

Ultraviolet-visible (uV-vis) spectroscopy was used to quantify the concentration of bromothymol blue in vials over the reaction period of 72 hours following composition of the solutions. Table 2 presents the concentrations of bromothymol blue in vials I-1 through I-4 and I-12 at times of 0, 2, 4, 24, and 72 hours following preparation of the solutions.

TABLE 2
Concentrations of bromothymol blue in vials I-1
through I-4 and I-12 at times of 0, 2, 4, 24, and
72 hours following preparation of the solutions

| | BTB Concentration (ppm) | | | | |
|---|---|---|---|---|---|
| Time (hr) | I-1 | I-2 | I-3 | I-4 | I-12 |
| 0 | 499 | 1089 | 409 | 1089 | 697 |
| 2 | 467 | 1089 | 272 | 1089 | 729 |
| 4 | 457 | 1089 | 194 | 1089 | 1089 |
| 24 | 336 | 1089 | 40 | 1089 | 370 |
| 70 | 270 | 1089 | 6 | 1089 | 264 |

The data are plotted in the graph entitled “Bromothymol Blue Concentrations vs. Time” and the spectrographic scans from which the data were derived are presented in the graphs entitled IW-1 through IW-4 and IW-12 (corresponding to vials I-1 through I-4 and I-12) in FIG. 2. Solutions in the I-2 and I-4 vials exhibited no reduction in bromothymol blue concentration, which indicated that the persulfate was stabilized, that is, there was no free radical production over the time period of 72 hours. Samples I-1 and I-3, which included Na-EDTA and Fe-EDTA, respectively, and did not include VeruSOL-3 exhibited decomposition of the bromothymol blue, which was indicative of the production of free radicals. For example, the solution in vial I-3, which included Fe-EDTA and sodium persulfate and did not include VeruSOL-3 exhibited a very rapid decrease in bromothymol blue concentration and, therefore, rapid free radical production.

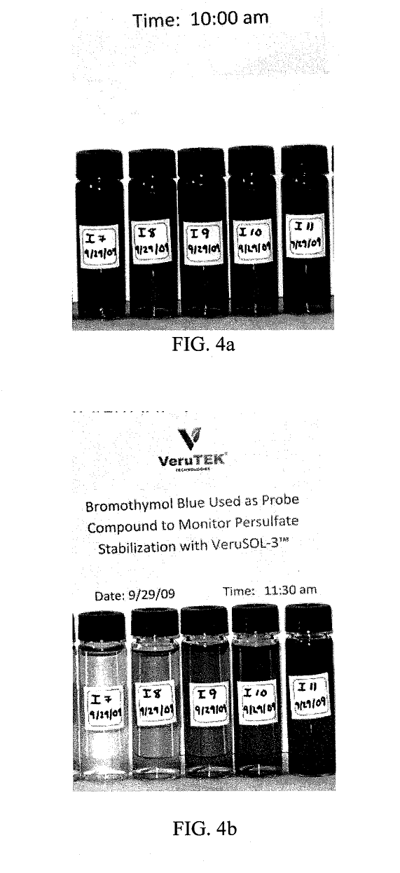

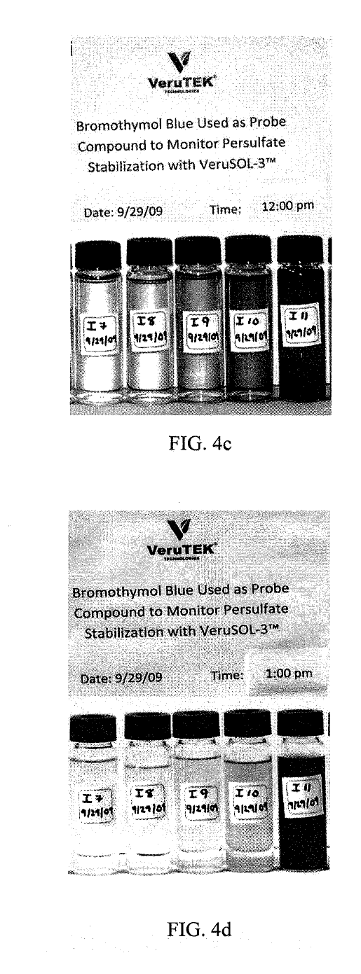

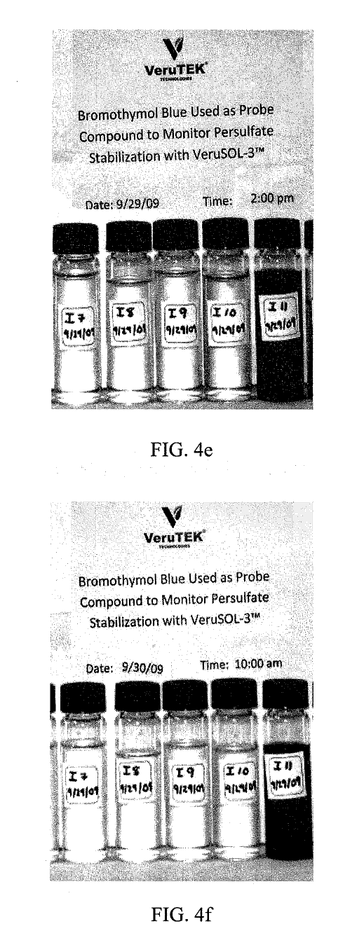

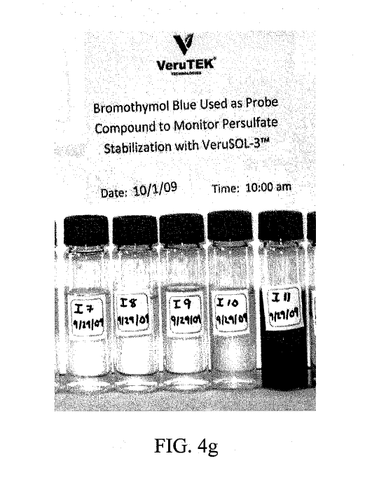

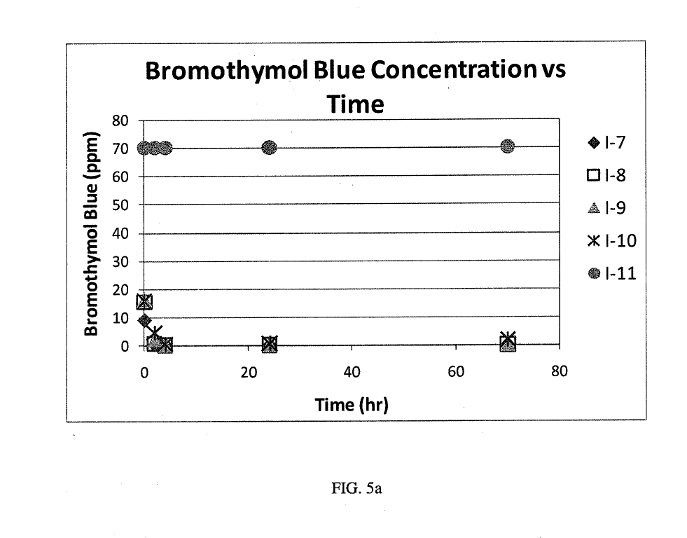

FIG. 4 presents close-up photographs of vials I-7 through I-11 at times of 0, 1.5, 2, 3, 4, 24, and 72 hours following composition of the solutions. In FIG. 4a, all vials are blue. In FIG. 4b, vial I-7 is clear, vial I-8 is light blue, vials I-9 and I-12 are progressively darker shades of blue. In FIG. 4c, vial I-7 is clear, vial I-8 is light green, vial I-9 is light blue, vial I-10 is blue, and vial I-11 is a somewhat darker shade of blue. In FIG. 4d, vial I-7 is clear, vials I-8 and I-9 are clear to light green, vial I-10 is light green, and vial I-11 is blue. In FIG. 4e, vials I-7 through I-9 are clear, vial I-10 is clear to light green, and vial I-11 is blue. In FIG. 4f, vials I-7 through I-10 are clear, and vial I-11 is blue. In FIG. 4g, vials I-7 through I-10 are clear, and vial I-11 is blue. As discussed above and shown in FIG. 1, the rate of color intensity reduction, indicative of the rate of bromothymol blue degradation correlated inversely with the concentration of VeruSOL-3 in the solutions of alkaline activated sodium persulfate. The solution of vial I-11 had pH>12, included no sodium persulfate, and served as a control. No change in the color of the solution of vial I-11 was observed, indicating that no radicals were produced.

Table 3 presents the concentrations of bromothymol blue in vials I-7 through I-11 at times of 0, 2, 4, 24, and 72 hours following composition of the solutions as determined from uV-vis spectroscopy.

TABLE 3
Concentrations of bromothymol blue in vials I-7 through I-11 at times
of 0, 2, 4, 24, and 72 hours following preparation of the solutions

BTB Concentration (ppm)

| Time (hr) | I-7 | I-8 | I-9 | I-10 | I-11 |
|---|---|---|---|---|---|
| 0 | 9.15 | 15.6 | 16.4 | 15.9 | 70.2 |
| 2 | 0.426 | 0.955 | 2.302 | 4.72 | 70.2 |
| 4 | 0.292 | 0.328 | 0.390 | 0.644 | 70.2 |
| 24 | 0.257 | 0.264 | 0.353 | 0.866 | 70.2 |
| 70 | 0.264 | 0.252 | 0.480 | 2.11 | 70.2 |

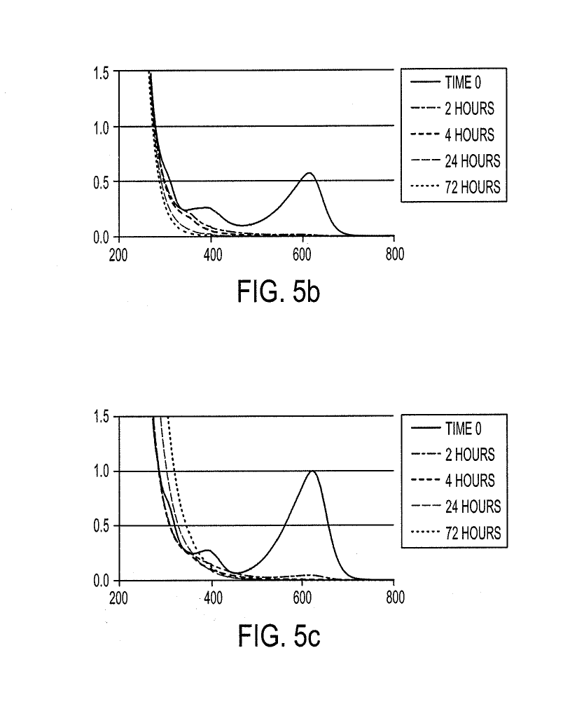

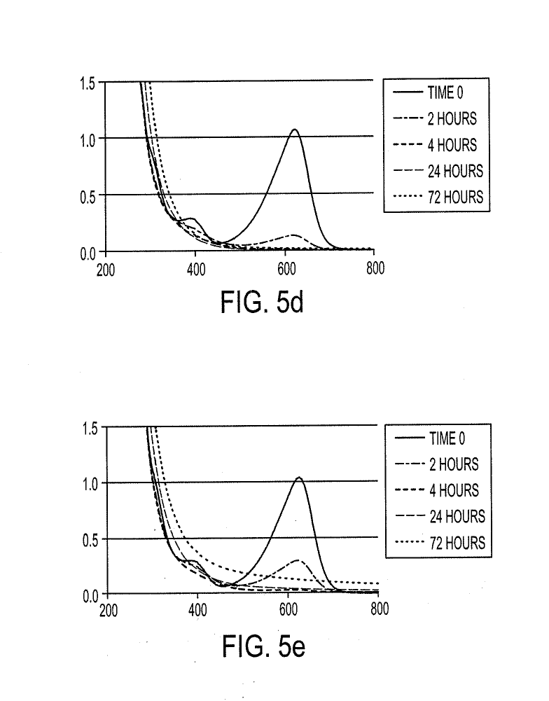

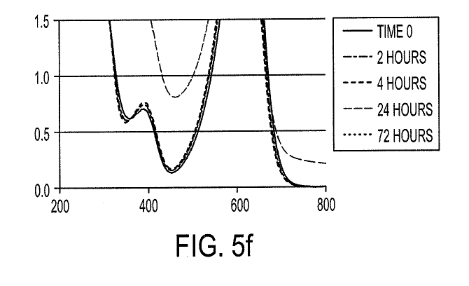

The data are plotted in FIG. 5a, the graph entitled “Bromothymol Blue Concentrations vs. Time” and the spectrographic scans from which the data were derived are presented in the graphs entitled IW-7 and I-8 through I-11 (corresponding to vials I-7 through I-11) in FIG. 5b-5f. The control solution in vial I-11, which had pH>12 and included no sodium persulfate, FIG. 5f, was the only solution that exhibited no decrease in color intensity, no decrease in bromothymol blue concentration, and, therefore, no production of free radicals. The solutions in the other vials containing alkaline activated sodium persulfate, I-7 through I-10, all exhibited decrease in color intensity and decrease in bromothymol blue concentration over time, indicating the production of free radicals. Although there may have been intitially a partial stabilization of persulfate, the concentration of VeruSOL-3 appeared to not have been high enough to stabilize the persulfate more fully.

Thus, in summary, VeruSOL-3 was able to reduce free radical formation and measurably stabilize persulfate for a prolonged period (at least 3 days), in the presence of an activator such as iron or alkalinity. The effectiveness of the surfactant in stabilizing the oxidant was concentration dependent. The effect was measurable at a concentration of surfactant of 0.3%, and increased at concentrations from 0.5% to 2%. The ratios of surfactant to oxidant were 1:10, 1:6, 1:3, and 1:1.5.

### Example 2

### Stabilization with VeruSOL-3™ of Peroxide Solutions Including Activator

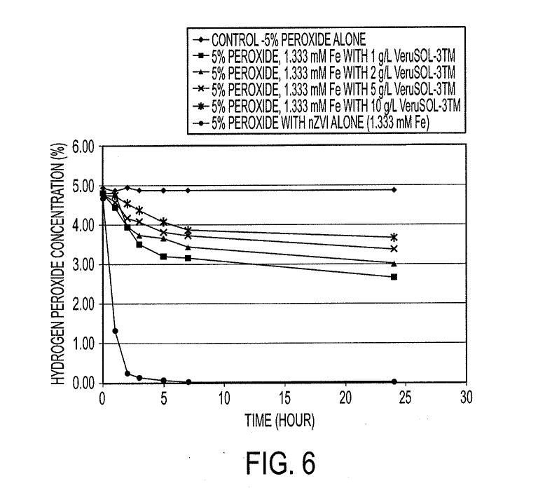

FIG. 6 presents the results of experiments in which the concentration of hydrogen peroxide in aqueous solutions was measured over time. The initial hydrogen peroxide concentration was about 5%. Aqueous solutions were made with only hydrogen peroxide, with hydrogen peroxide and nanoscale zero valent iron (nZVI) as an activator, and with hydrogen peroxide, nZVI, and VeruSOL in concentrations of 1, 2, 5, and 10 g/L. The solution of hydrogen peroxide and activator with not VeruSOL exhibited a rapid decrease in hydrogen peroxide concentration. The solutions with hydrogen peroxide, activator, and VeruSOL exhibited a slower rate of hydrogen peroxide concentration. The greater the concentration of VeruSOL, the slower the rate of hydrogen peroxide decomposition.

### Example 3

### Stabilization of Hydrogen Peroxide with Plant-Derived Surfactants

In several trials, an aqueous solution of hydrogen peroxide and a low concentration of VeruSOL was sealed in a vessel with a pressure gauge. Little or no increase in pressure was observed over time, indicating that the hydrogen peroxide was not decomposing into oxygen gas. That is, the VeruSOL stabilized the hydrogen peroxide against decomposition.

### Example 4

### Stabilized Hydrogen Peroxide Treatment of Coal Tar Non Aqueous Phase Liquids

Two soil columns were set up and run to evaluate the effects of VeruSOL-3 on the stability of hydrogen peroxide and the performance of catalyzed hydrogen peroxide alone and also with VeruSOL-3 to treat soils with Coal Tar dense non aqueous phase liquids (DNAPL) obtained from a former Manufactured Gas Plant Site (MGP). Soil columns were packed with 950 g clean ASTM fine sand and 8 g of Coal Tar DNAPL was injected into the center of the column. Soil columns numbered 4 and 5 received an influent of 0.5 mL/min of 8 percent hydrogen peroxide and 250 mg/L as Fe solution of Fe-EDTA for a 14 day period. Fe-EDTA was added as an activator for free radical formation associated with catalyzed hydrogen peroxide to each of the soil columns 4 and 5. Additionally, influent to soil column 4 received 10 g/L of VeruSOL-3, added to the combined influent to this soil column. Therefore, the only difference between the catalyzed hydrogen peroxide treatment of soil columns 4 and 5 was that 10 g/L of VeruSOL-3 was added to soil column 4, making it a S-ISCO column treatment. Soil column 5 received an ISCO treatment alone (without surfactant).

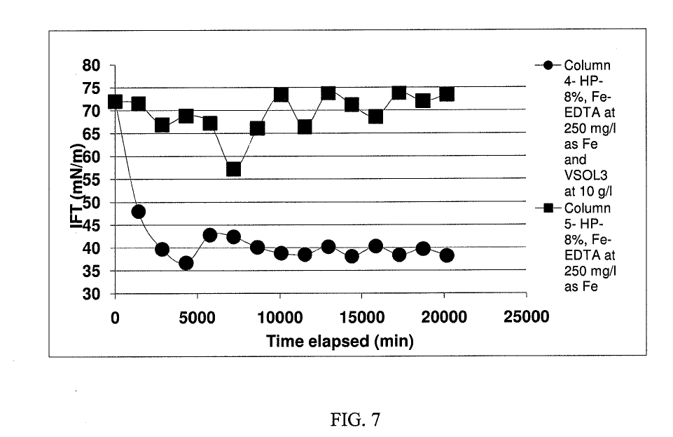

Over the 14 day test period hydrogen peroxide and interfacial tension measurements were made on a daily basis on the soil column effluents. It can be seen in FIG. 7 that the interfacial tension measurements in soil column 5 varied generally between 67 mN/m and 73 mN/m, typical of a system that contains no added surfactant. However, the interfacial tension measurements in soil column 5 decreased to 39.7 mN/m within 2 days of treatment and remained low for the 14 day test generally in the 28 mN/m to 40 mN/m range. Influent IFT to soil column 4 varied from 33.1 mN/m to 37.1 mN/m for the duration of the test, indicating the effectiveness of the surfactant in the system. Influent to soil column 5 without VeruSOL-3 added varied from 71.5 mN/m to 74.9 mN/m typical of water alone.

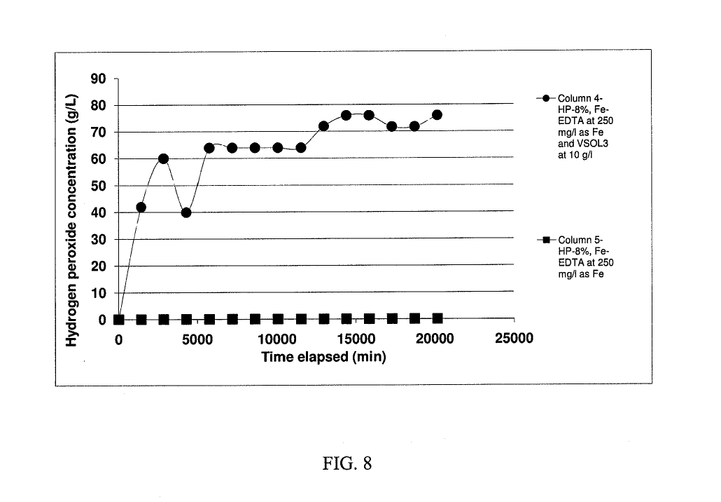

Results of the effluent hydrogen peroxide measurements in soil columns 4 and 5, shown in FIG. 8, indicates that hydrogen peroxide was never detected in the effluent of soil column 5 which received no VeruSOL-3 surfactant-cosolvent in the influent. The detection limit for the hydrogen peroxide was 0.03 g/L. However, S-ISCO soil column 4 which received the VeruSOL-3 in addition to catalyzed hydrogen peroxide exhibited a rapid increase in hydrogen peroxide concentration to greater than 40 g/L after 1 day of treatment and then increased to 71.7 g/L to 75.9 g/L for the past 6 days of the test. Influent hydrogen peroxide measurements to soil columns 4 and 5 were typically 79.3 g/L. It is evident that the present of VeruSOL-3 had a dramatic effect on stabilizing the hydrogen peroxide in the S-ISCO soil column 4, allowing the system to maintain the ˜8% concentration of the influent hydrogen peroxide during a two week period in an activator-containing system. It is also evident, as expected, that if hydrogen peroxide is not stabilized, then its decomposition is rapid and will not even travel through the 300 cm long soil column.

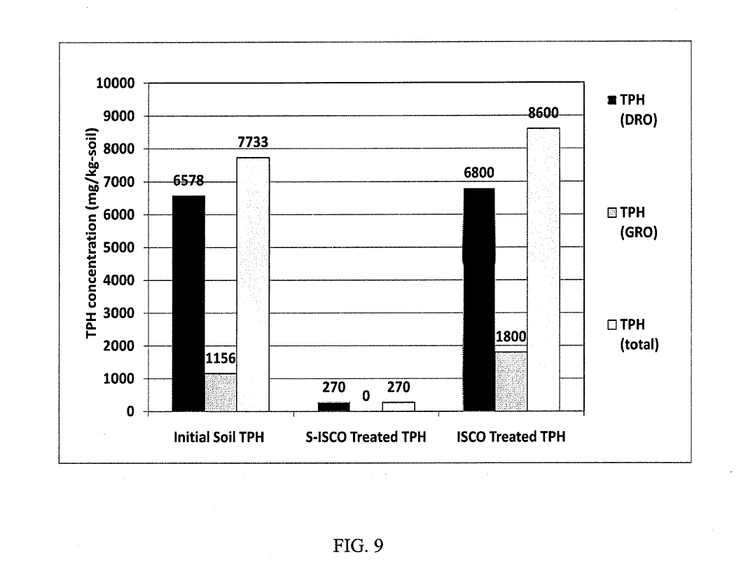

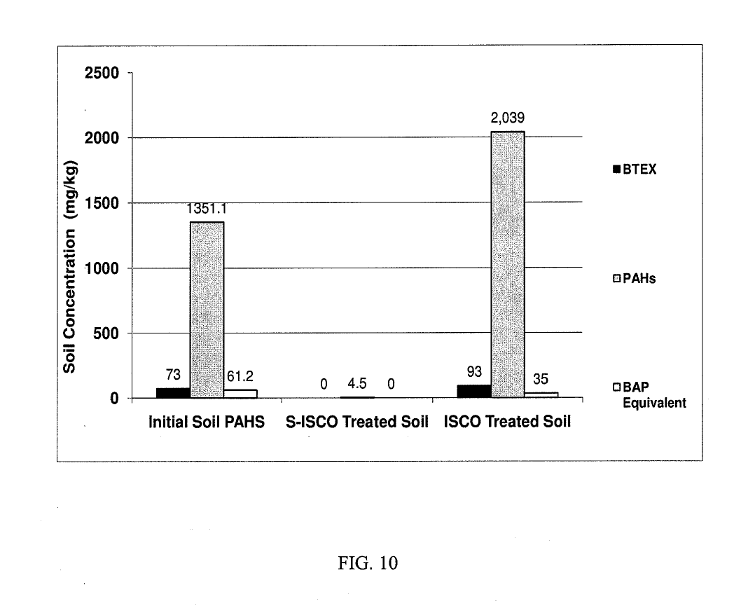

Following the 14 day treatment, the soil columns were sacrificed and the soil in the two columns were sampled identically, by sampling the area where the DNAPL was emplaced in the soil. Additionally, a control soil column test was run with no treatment, other than passing 0.5 mL/min of deionized water through for a 14 day period. The post-treated soil was analyzed for volatile organic compounds (VOCS) (USEPA Method 8260, semi-volatile organic compounds (SVOCs), including polyaromatic hydrocarbons (PAHs)(USEPA Method 8270B) and Total Petroleum Hydrocarbons (TPH) for the Diesel Range Organics (DRO) and Gasoline Range Organics (GRO) (USEPA Method 8015D). It can be seen from FIG. 9 that the Total Petroleum Hydrocarbons concentrations in soils from the control column was 7,733 mg/kg, the S-ISCO treated soil (column 4) with catalyzed hydrogen peroxide and VeruSOL-3 was 270 mg/kg and the ISCO catalyzed hydrogen peroxide alone treated soil (column 5) was 8,600 mg/kg. The S-ISCO treated soil additionally had non detection of GRO, while the control column soil had a concentration of 1,156 mg/kg and the ISCO catalyzed hydrogen peroxide alone treated soil (column 5) had a concentration of 1,800 mg/kg. Similar trends in treatment effectiveness, as measured by Total benzene, ethyl benzene, toluene and xylenes (BTEX) and PAHs, as well as the calculated benzo[α]pyrene equivalents are seen in FIG. 10. The Total BTEX concentration in the S-ISCO treated soil was non-detected, whereas the Control column and the ISCO column had 73 mg/kg and 93 mg/kg, respectively in the posted treated soil. The Total PAH concentration in the S-ISCO treated soil was 4.5 mg/kg, whereas the Control column and the ISCO column had 1351.1 mg/kg and 2,039 mg/kg, respectively in the posted treated soil. A known method of calculating the relative toxic potency of PAH compounds in soils is to calculate the potency in terms of Benzo [α] Pyrene equivalents. This calculation was conducted for the soil from the control column, as well as for the S-ISCO (column 4) and the ISCO (column 5) tests. The Benzo [α] Pyrene equivalent concentration for the control column soil after 14 days was 61.2 mg/kg. The Benzo [α] Pyrene equivalent concentrations for the S-ISCO (column 4) and the ISCO (column 5) after 14 days was non-detectable and 35 mg/kg.

The results of the soil column tests to evaluate coal tar DNAPL contaminated soil treatment performance and the ability to stabilize hydrogen peroxide, indicate that the ability of S-ISCO treatment with a catalyzed composition of hydrogen peroxide and VeruSOL-3 is able to treat these contaminated soils to a high degree of effectiveness. The ability to reduce Total TPH, BTEX and PAH concentrations from those of highly coal tar DNAPL contaminated soil was substantial with final concentrations of 270 mg/kg, non-detected and 4.5 mg/kg, respectively. In comparison those same Total TPH, BTEX and PAH concentrations in the control column of 6,578 mg/kg, 73 mg/kg and 1,351 mg/kg, the S-ISCO treatment results are significant. In comparison those same post-treatment Total TPH, BTEX and PAH concentrations in the ISCO treated column of 6,800 mg/kg, 93 mg/kg and 2,039 mg/kg, the S-ISCO treatment results are unexpected and dramatic. Again, the only difference between the S-ISCO treated soils and the ISCO treated soil was the presence of VeruSOL-3 at 10 g/L, in the influent. As significant is the observation that in addition to providing a high degree of treatment of the TPH, Total BTEX and PAH contamination in the coal tar DNAPL contaminated soil, analyzed following USEPA Methods, is that the presence of the VeruSOL-3 stabilizes the hydrogen peroxide enabling the hydrogen peroxide to persist in soils rather the being rapidly degraded when the VeruSOL-3 is not present as with catalyzed hydrogen peroxide alone. The increase treatment effectiveness of the S-ISCO process with catalyzed hydrogen peroxide is the result of emulsifying the Coal Tar DNAPL into an emulsion phase where chemical oxidants can destroy the Coal Tar DNAPL, but also to stabilize the hydrogen peroxide enabling it, when activated, to destroy the emulsified Coal Tar DNAPL.

Thus, a composition with 1% nonionic plant-derived surfactant and 8% hydrogen peroxide is effective in solubilizing and/or emulsifying nonaqueous contaminants over a prolonged time, while stabilizing the oxidant and enabling it to be effective in oxidizing the contaminants.

### Example 5

### Long term Stability of Hydrogen Peroxide with VeruSOL-3 and VeruSOL-10

Experiments were conducted to evaluate the stabilization and possible degradation of surfactant and decomposition of hydrogen peroxide in the presence of a surfactant-cosolvent mixture (VeruSOL-3) and a mixture of surfactants (VeruSOL-10).

The experimental design utilized two concentrations of hydrogen peroxide (8 percent and 30 percent). VeruSOL-3 and VeruSOL-10 were tested for their ability to resist hydrogen peroxide decomposition and to stabilize hydrogen peroxide. Reactors in which the experiments were conducted were dark brown HPDE plastic containers affixed with pressure gauges. Samples were obtained over a time period of 7 months and analyzed for interfacial tension (IFT), temperature and hydrogen peroxide, as shown in Table 4, below. Control reactors were also set up without any surfactant mixture present at both 8 percent and 30 percent hydrogen peroxide concentrations.

TABLE 4
Long term hydrogen peroxide stabilization tests

[symbol]

| | | Total | | | Surfactant | | | |
|---|---|---|---|---|---|---|---|---|
| Sample | | Volume | | | Concentration | Sampling | | |
| ID | Description | (mL) | HP (%) | Surfactant | (g/L) | Frequency | Parameters | Notes |
| S-1 | Control | 750 | 8 | None | 0 | Time 0, periodic | HP, IFT, Temp | Do not uncap until end of |
| | | | | | | measurements | | experiment |
| S-2 | HP with VS-3 | 750 | 8 | VeruSOL-3 | 20 | Time 0, periodic | HP, IFT, Temp | Do not uncap until end of |
| | | | | | | measurements | | experiment |
| S-3 | HP with VS-10 | 750 | 8 | VeruSOL-10 | 20 | Time 0, periodic | HP, IFT, Temp | Do not uncap until end of |
| | | | | | | measurements | | experiment |
| S-4 | Control | 750 | 30 | None | 0 | Time 0, periodic | HP, IFT, Temp | Do not uncap until end of |
| | | | | | | measurements | | experiment |
| S-5 | HP with VS-10 | 750 | 30 | VeruSOL-10 | 100 | Time 0, periodic | HP, IFT, Temp | Do not uncap until end of |
| | | | | | | measurements | | experiment |

[symbol]

indicates data missing or illegible when filed

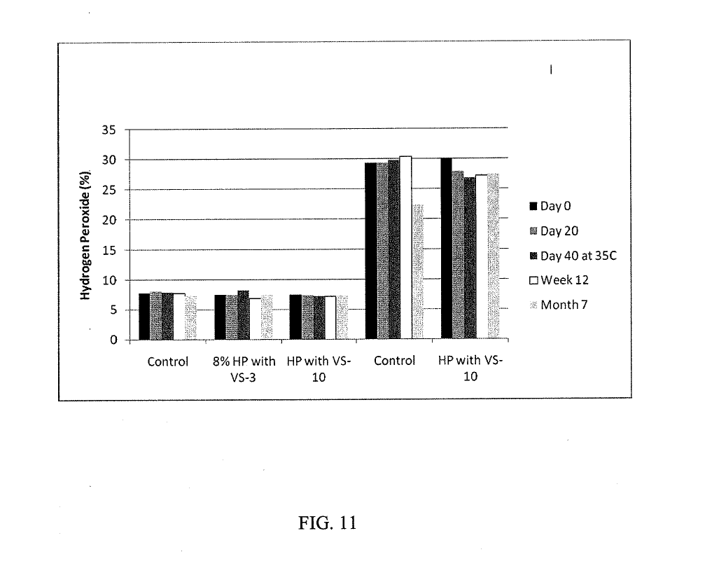

The effects of VeruSOL-3 and VeruSOL-10 stabilization of hydrogen peroxide can be seen in FIG. 11. It is evident that over a 7 month period there was no decomposition of the 8% hydrogen peroxide formulation in either the control reactor or in the reactors with 20 g/L of either VeruSOL-3 or VeruSOL-10. However, the 30% hydrogen peroxide control reactor was observed to have a hydrogen peroxide concentration decrease from 29.3 percent to 22.3 percent, a 23.89 percent decrease. At the 30 percent hydrogen peroxide concentration tested with VeruSOL-10 there was a smaller decrease in the hydrogen peroxide concentration after 7 months, decreasing from an initial concentration of 30.1 percent to a concentration of 27.3 percent after 7 months, a 9.30 percent decrease. Thus, upon prolonged storage, the surfactant stabilized formulation maintained greater than about 90% of the original peroxide concentration, while the surfactant-free control had about 75% of the original concentration.

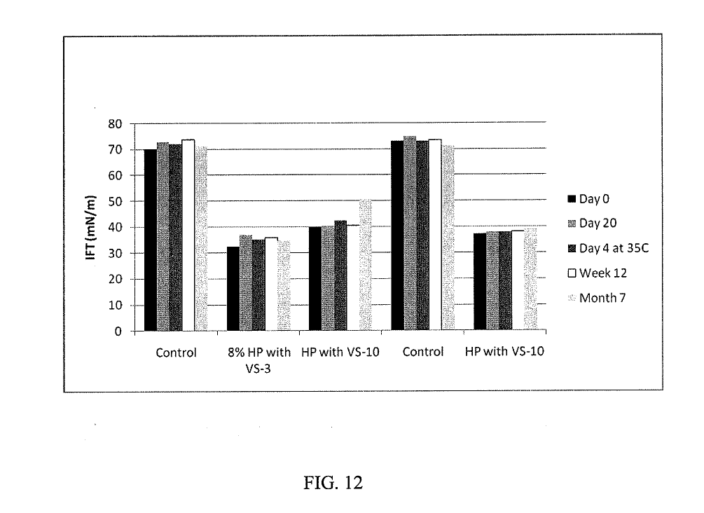

Interfacial tension measurements are indicative of the activity of the surfactant or surfactant-cosolvent mixtures to resist degradation the result of storage with hydrogen peroxide, as well as the stability of the surfactant-hydrogen peroxide mixtures. Results of the effects of long term storage of hydrogen peroxide and the VeruSOL mixtures are presented in FIG. 12. Adding surfactant to the 8% and 30% peroxide controls reduced IFT. VeruSOL-3 reduced IFT more than VeruSOL-10. An increase in IFT over time is indicative of degradation of the surfactant mixture by hydrogen peroxide. It can be seen that 2% VeruSOL-3 exhibited no measureable increase of interfacial tension over time, and therefore was not degraded by the peroxide. At 30 percent hydrogen peroxide and 100 g/L VeruSOL-10 concentrations, there was likewise no measureable increase of interfacial tension measurements over the 7 month period, indicating that the surfactant was not degraded. The results for the 8 percent hydrogen peroxide concentration and 20 g/L VeruSOL-10 concentration show a an increase in interfacial tension measurement after a 7 month period. However, after 12 weeks of storage of the 8 percent hydrogen peroxide concentration and 20 g/L VeruSOL-10 concentration mixture, there was no measured change in IFT from the initial value. Because there was no change in hydrogen peroxide measurements over time for the 8 percent hydrogen peroxide concentration and 20 g/L VeruSOL-10 concentration mixture, showing stability of the hydrogen peroxide, the measured increase in IFT in this reactor at 7 months is anomalous and likely erroneous.

Overall, both VeruSOL-3 and VeruSOL-10 exhibited the ability to stabilize hydrogen peroxide decomposition and resisted degradation by hydrogen peroxide.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described. All references cited herein are incorporated by reference as if each had been individually incorporated. For example, international application numbers PCT/US2007/007517, filed on Mar. 27, 2007 and published as WO2007/126779 on Nov. 8, 2007, and PCT/US2009/044402, filed on May 18, 2009, U.S. patent application Ser. No. 12/068,653, filed on Feb. 8, 2008 and published as US 2008-0207981A1 on Aug. 28, 2008, and U.S. provisional applications 61/071,785, filed on May 16, 2008; 61/246,953, filed on Sep. 29, 2009; and 61/251,291, filed Oct. 13, 2009, are hereby incorporated by reference in their entirety.

1. A storage-stable composition, comprising:
a nonionic plant-derived surfactant in a concentration of at least about 10 g/L; and
an oxidant in a concentration of about 1% (w/v) to about 10% (w/v);
wherein the oxidant is stable during the shelf life of the composition.

2. The composition of claim 1, wherein the oxidant is hydrogen peroxide.

3. The composition of claim 2, wherein the hydrogen peroxide concentration is about 1% (w/v) to about 4% (w/v).

4-5. (canceled)

6. The composition of claim 1, wherein the shelf life is at least about 6 months.

7. The composition of claim 1, wherein the plant-derived surfactant concentration is about 10 to about 100 g/L.

8. (canceled)

9. The composition of claim 1, wherein the plant-derived surfactant comprises a component selected from the group consisting of an ethoxylated soybean oil, an ethoxylated castor oil, an ethoxylated coconut fatty acid, an amidified, ethoxylated coconut fatty acid and combinations.

10. The composition of claim 1, further comprising a cosolvent.

11. The composition of claim 10, wherein the cosolvent comprises a component selected from the group consisting of a carboxylate ester, a plant-based ester, a terpene, a citrus-derived terpene, limonene, d-limonene, isopropyl alcohol, t-butyl alcohol and combinations.

12. The composition of claim 1, wherein the pH is from about 4 to about 7.

13. The composition of claim 1, further comprising a stannate in an amount less than about 150 mg/L as tin.

14. The composition of claim 2, further comprising a phosphonic acid compound in an amount less than about 0.025 percent of the hydrogen peroxide concentration.

15-17. (canceled)

18. The composition of claim 1, wherein the plant-derived surfactant is resistant to degradation by the oxidant, and the oxidant is resistant to degradation by the plant-derived surfactant.

19. A storage-stable composition, comprising:
a plant-derived surfactant; and
an oxidant;
wherein the surfactant concentration is at least about 10 g/L, and the ratio of the mass per volume concentration of plant-derived surfactant to the mass per volume concentration of the oxidant is greater than about 1:5; and
wherein the oxidant is stable during the shelf life of the composition.

20. The composition of claim 19, wherein the oxidant is hydrogen peroxide.

21-22. (canceled)

23. The composition of claim 19, wherein the shelf life is at least about 6 months.

24. The composition of claim 19, wherein the plant-derived surfactant comprises a component selected from the group consisting of an ethoxylated soybean oil, an ethoxylated castor oil, an ethoxylated coconut fatty acid, an amidified, ethoxylated coconut fatty acid and combinations.

25. The composition of claim 19, further comprising a cosolvent.

26-27. (canceled)

28. A storage-stable composition, comprising:
a nonionic plant-derived surfactant in a concentration of greater than 2 g/L; and
a peroxide in a concentration of at least about 1% (w/v);
wherein the oxidant and the surfactant are stable for at least one month.

29-39. (canceled)
